(19) United States
(12) Patent Application Publication
(10) Pub. No.: US 2012/0039339 A1
(43) Pub. Date: Feb. 16, 2012

(54) COMMUNICATION APPARATUS, RELAY APPARATUS, AND COMMUNICATION CONTROL METHOD

(75) Inventor: Toshihiko KURITA, Kawasaki (JP)

(73) Assignee: FUJITSU LIMITED, Kawasaki-shi (JP)

(21) Appl. No.: 13/206,335

(22) Filed: Aug. 9, 2011

(30) Foreign Application Priority Data
Aug. 11, 2010 (JP) 2010-180034

(51) Int. Cl. H04L 12/56

(52) U.S. Cl. 370/400

(57) ABSTRACT

A relay apparatus including: a plurality of communication interfaces; and a processor configured to detect a collision, at which a second communication interface receives a second control packet group from a second communication apparatus while a first communication interface receives one of a first data packet group and a first control packet group from a first communication apparatus, the second control packet group being used to reserve a transmission of a second data packet group during a constant period later than a present frame by one frame out of a frame string representing an operation period of the second communication apparatus, and a communication interface of the second control packet group matching a communication interface of one of the first data packet group and the first control packet group; and transmit a collision occurrence notification to the second communication apparatus.

### CROSS-REFERENCE TO RELATED APPLICATION

This application is based upon and claims the benefit of priority from the prior Japanese Patent Application No. 2010-180034 filed on Aug. 11, 2010, the entire contents of which are incorporated herein by reference.

### FIELD

The technique relates to communication control of a wired network.

### BACKGROUND

An amount of traffic flowing through information communication networks has substantially increased recently, and power consumption has also increased in the networks accordingly. In particular, power consumption of routers is pronounced.

Techniques for transmitting data in a time-division manner (such as time division multiplexing (TDM)) are available. In TDM, one frame is segmented into a plurality of time slots (hereinafter simply referred to as a slot), and different data are transferred on a per slot basis. When data are transferred in TDM, communication apparatuses perform precise time synchronization. High-precision time counting function satisfying IEEE 1588 standards is used, leading to a cost increase.

Related art techniques are described in Japanese Unexamined Patent Application Publication Nos. 3-46432 and 2006-277306.

### SUMMARY

According to an aspect of the invention, a relay apparatus including: a plurality of communication interfaces; and a processor configured to detect a collision, at which a second communication interface receives a second control packet group from a second communication apparatus while a first communication interface receives one of a first data packet group and a first control packet group from a first communication apparatus, the second control packet group being used to reserve a transmission of a second data packet group during a constant period later than a present frame by one frame out of a frame string representing an operation period of the second communication apparatus, and a communication interface of the second control packet group matching a communication interface of one of the first data packet group and the first control packet group; and transmit a collision occurrence notification to the second communication apparatus in response to a detection of the collision, the collision occurrence notification including adjustment time longer than time from a reception start of a leading packet of the second control packet group to a reception end of a trailing packet of one of the first data packet group and the first control packet group.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of a network system of an embodiment of the technique;

FIG. 2 is a function block diagram of an edge router;

FIG. 3 illustrates an example of a destination node table;

FIG. 4 illustrates an example of a queue management table;

FIG. 5A illustrates an example of data stored on a schedule database (DB);

FIG. 5B illustrates a relationship between a frame and a slot in an edge node;

FIG. 6A illustrates a structure of a control packet group;

FIG. 6B illustrates a structure of a data packet group;

FIG. 7 is a function block diagram of a relay router of a first embodiment;

FIG. 8 illustrates an example of a relay table;

FIG. 9 is a function block diagram of a management server;

FIG. 10 illustrates a flow of a transmission reservation of a data packet;

FIG. 11 illustrates an operation performed in response to an occurrence of a collision;

FIG. 12 illustrates a sequence performed during the occurrence of the collision;

FIG. 13 illustrates a process flow of the edge node performed when a packet is received from an external network;

FIG. 14 illustrates a process flow of a transmission reservation process;

FIG. 15 illustrates a process flow of the edge node performed when a control packet group is received;

FIG. 16 illustrates a process flow of a relay router performed when a data packet group is received;

FIG. 17 illustrates a process flow of the relay router performed when a control packet group is received;

FIG. 18 diagrammatically illustrates an IP packet and an IP header;

FIG. 19A illustrates a format of an option field in a collision occurrence notification;

FIG. 19B illustrates a format of an option field in an acknowledgement notification;

FIG. 20 illustrates a network configuration including three edge nodes connected to a relay node;

FIG. 21 illustrates an operation performed in the collision occurrence in the network illustrated in FIG. 20;

FIG. 22 illustrates a sequence example of a second embodiment;

FIG. 23 is a function block diagram of a relay router of the second embodiment;

FIG. 24 illustrates a process flow of the relay router of the second embodiment;

FIG. 25 is a continuation of the process flow of FIG. 24;

FIG. 26 is a continuation of the process flow of FIG. 25;

FIG. 27 is a sequence example of a third embodiment;

FIG. 28 is a function block diagram of a relay router of the third embodiment;

FIG. 29 illustrates an example of a relay table of the third embodiment;

FIG. 30 illustrates an example of data stored on a shift time storage unit;

FIG. 31 illustrates a process flow of a second transmission reservation process;

FIG. 32 illustrates a format of an option field of a use enable period data and a transmission enable period data;

FIG. 33 illustrates a process flow of the relay router of the third embodiment;

FIG. 34 illustrates a process of identifying an overlapping period of a use enable period and an idling period;

FIG. 35 is a continuation of the process flow of FIG. 33;

FIG. 36 is a process flow of the relay router of the third embodiment;

FIG. 37 illustrates an update process of a reservation period;

FIG. 38 is a function block diagram of a computer;

FIG. 39 is a function block diagram of a computer;

FIG. 40 is a function block diagram of a relay apparatus;

FIG. 41 is a function block diagram of a communication apparatus;

FIG. 42 illustrates a process flow of a communication control method; and

FIG. 43 illustrates a process flow of a communication control method.

### DESCRIPTION OF EMBODIMENTS

The technique in one aspect is directed to communications that allow a plurality of communication apparatuses, which are not synchronized, to communicate with each other over a wired network in a time-division manner.

### First Embodiment

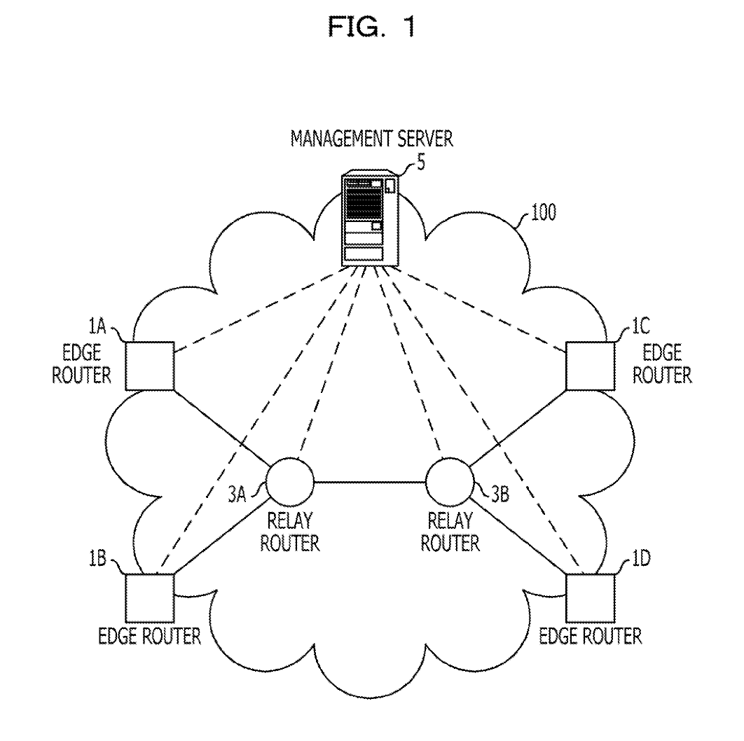

Referring to FIGS. 1-21, the first embodiment is described below. As illustrated in FIG. 1, a network system 100 of the embodiment includes edge routers 1 (1A-1D in FIG. 1), relay routers 3 (3A and 3B in FIG. 1), and management server 5. As illustrated in FIG. 1, the relay router 3A is connected to the edge router 1A, the edge router 1B, and the relay router 3B. The relay router 3B is connected to the edge router 1C and the edge router 1D. The edge routers 1A-1D, and the relay routers 3A and 3B are connected to the management server 5 via control lines (denoted by broken lines in FIG. 1). The edge routers 1A-1D are also connected to an external network (not illustrated). In the discussion that follows, the edge router is also referred to as an edge node, and the relay router is also referred to as a router node. FIG. 1 is an example of a simple network, and the network configuration is not limited to this example.

As illustrated in FIG. 1, the management server 5 delivers data representing a frame length to the edge routers 1A-1D at startup. The edge routers 1A-1D thus receive the data representing the frame length from the management server 5, and operate in accordance with the frame length. The discussion here is based on the premise that the edge routers 1A-1D operate in an asynchronous fashion, and that the frame start timings of the edge routers 1A-1D are not synchronized.

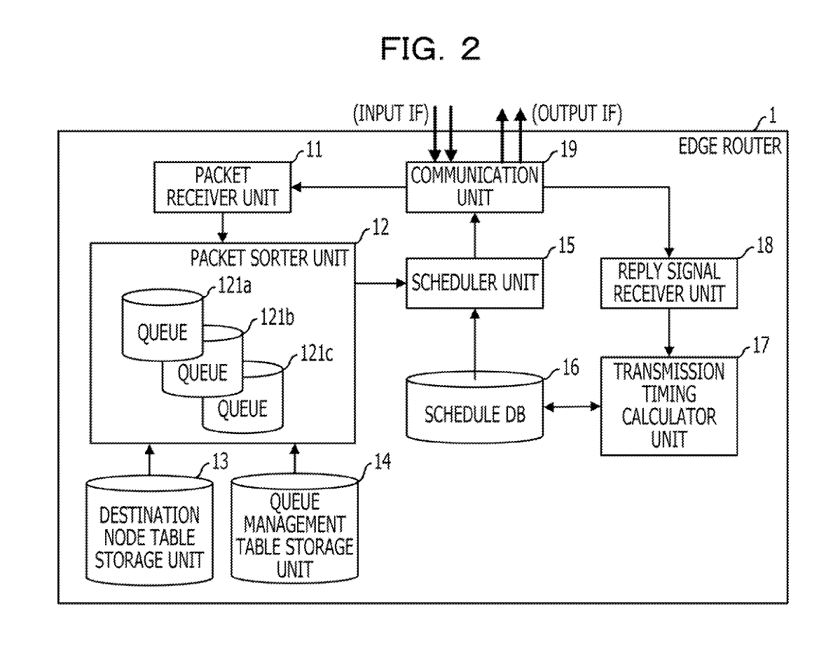

FIG. 2 is a function block diagram of the edge router 1 of FIG. 1. The edge router 1 includes packet receiver unit 11, packet sorter unit 12 including queues 121 for destination edge nodes (121a-121c in FIG. 2), destination node table storage unit 13, queue management table storage unit 14, scheduler unit 15, schedule database (DB) 16, transmission timing calculator unit 17, reply signal receiver unit 18, and communication unit 19. The communication unit 19 is connected to a plurality of input-output interfaces (IF).

The packet receiver unit 11 receives a packet from the external network via the communication unit 19, and outputs the received packet to the packet sorter unit 12. The packet sorter unit 12 stores the packet received by the packet receiver unit 11 onto a corresponding queue 121 using data stored on the destination node table storage unit 13 and the queue management table storage unit 14. If no corresponding queue 121 is present, the packet sorter unit 12 generates a new queue 121, and then registers a queue ID on the queue management table storage unit 14. If the new queue 121 has been generated, the packet sorter unit 12 instructs the scheduler unit 15 to reserve communication of the packet stored on the packet sorter unit 12 (also referred to as a data packet). In response to the instruction from the packet sorter unit 12, the scheduler unit 15 queries the management server 5 about a communication path of the data packet. The scheduler unit 15 also transmits a control packet group for transmission reservation of the data packet to a destination edge node via the communication unit 19 in accordance with the data stored on the schedule DB 16. The reply signal receiver unit 18 receives a reply to the control packet group via the communication unit 19, and outputs the reply to the transmission timing calculator unit 17. In response to the reply to the control packet group, the transmission timing calculator unit 17 calculates a transmission timing of the control packet group, and then stores the transmission timing on the schedule DB 16. If the transmission reservation of the data packet is complete, the scheduler unit 15 transmits the data packet group to the destination edge node via the communication unit 19 in accordance with the data stored on the schedule DB 16.

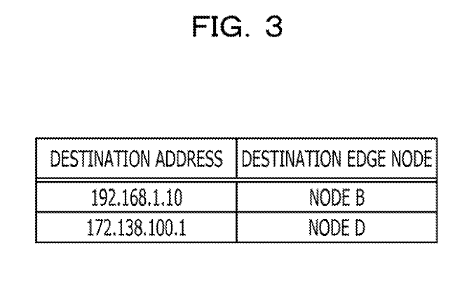

The destination node table storage unit 13 pre-stores a destination node table of FIG. 3. The destination node table of FIG. 3 includes a destination address column and a destination edge node column. If a destination address is 192.168.1.10, a destination edge node is node B.

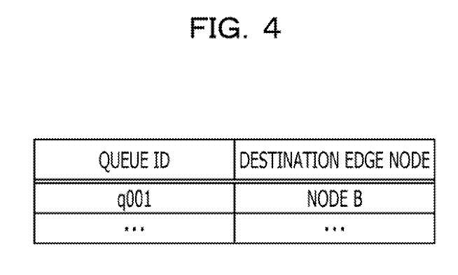

The queue management table storage unit 14 stores a queue management table of FIG. 4. The queue management table of FIG. 4 includes a queue ID column, and a destination edge node column. A packet storage destination with the destination edge node being node B is queue having ID “q001.”

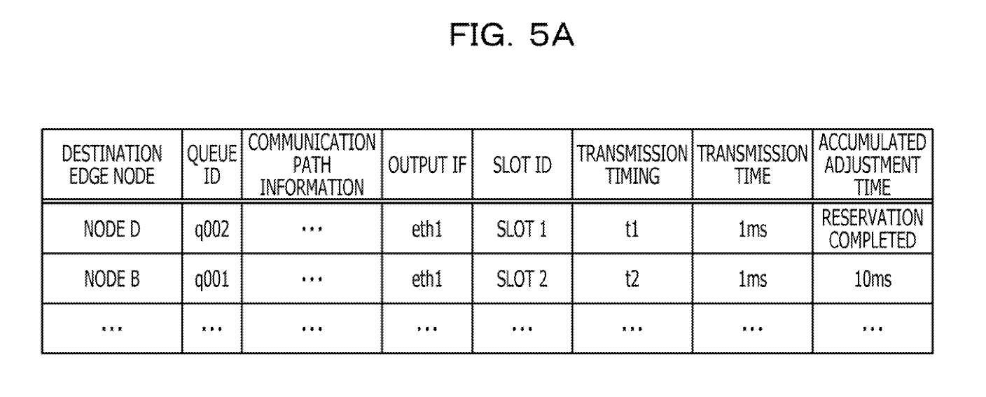

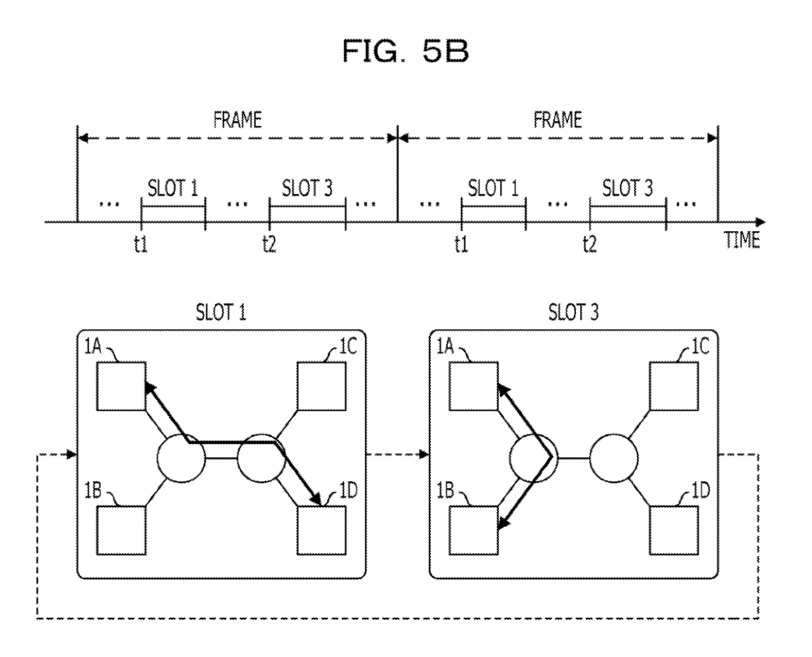

Data of FIG. 5A is stored on the schedule DB 16. The schedule DB 16 of FIG. 5A includes, on a per destination edge node basis, queue ID, communication path information, output interface (IF), slot ID, transmission timing, transmission time, and accumulated adjustment time. Upon receiving an instruction to reserve transmission of a data packet from the packet sorter unit 12, the scheduler unit 15 adds a new record on the schedule DB 16. The column of the queue ID column lists a queue ID of the queue 121 storing a packet to be transmitted to the destination edge node of the record. The column of the communication path information lists communication path information received from the management server 5. The column of the output IF lists identification information of the IF serving as an output destination of the data packet addressed to the destination edge node of the record. The column of the slot ID lists an ID of the slot for communication with the destination edge node of the record. In the embodiment, the ID set in the slot ID column is set in a leading packet and a trailing packet of the data packet group and then the data packet group is transmitted as will be described in detail below. The column of the transmission timing lists a time at which a packet transmission starts with respect to a frame start time of own edge node. If a packet collision occurs in the relay router 3 in the communication path, the transmission timing is shifted by the adjustment time of which the relay router 3 has notified as will be described below in more detail. If the transmission reservation of the data packet is complete, “reservation completed” is set in the column of the accumulated adjustment time. The column of the transmission time lists a time from the start of the packet transmission to the end of the packet transmission. As illustrated in FIG. 5A, the reservation of the packet transmission to the node D is complete. The data packet stored at ID “q002” is scheduled to be output to an output IF of eth1 within the period (slot 1) of 1 ms from time t1 of own edge node. The transmission reservation of the packet transmission to the node B is not complete, and time t2 is shifted by 10 ms from the first transmission timing.

FIG. 5B diagrammatically illustrates the relationship between a slot and a frame in the edge node 1A. As illustrated in FIG. 5B, a fixed length frame having a variable-length slot is periodically repeated. For example, the edge node 1A transmits a control packet group for the transmission reservation of the data packet to the edge node 1D in a slot 1 in a given frame. Upon receiving an acknowledgement notification from the edge node 1D, the edge node 1A performs packet communication with the edge node 1D in the slot 1 on the next frame thereafter. Similarly, the edge node 1A transmits the control packet group to the edge node 1B in a slot 3 of a given frame. Upon receiving an acknowledgement notification from the edge node 1B, the edge node 1A performs packet communication with the edge node 1B in the slot 3 on the next frame thereafter. It is noted that the edge node 1 allocates the slot ID in the transmission reservation of the data packet regardless of the arrangement order of the slots. For this reason, the slots within the frame are not necessarily arranged in the order of the slot IDs. According to the embodiment, a slot for transmitting the control packet group is referred to a control slot, and a slot for transmitting the data packet group is referred to as a data slot.

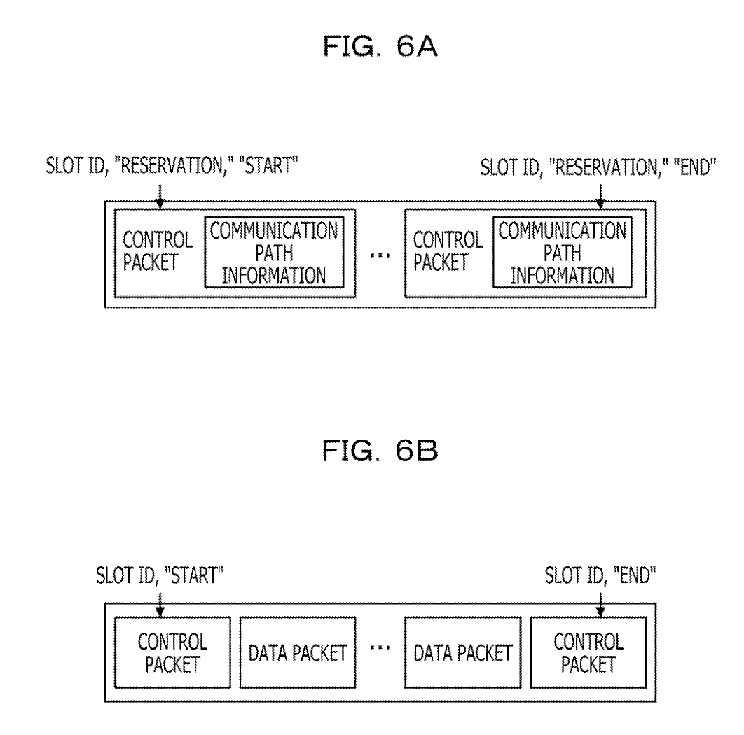

FIGS. 6A and 6B illustrate the structure of the control packet group and the data packet group in the embodiment. FIG. 6A illustrates the structure of the control packet group. As illustrated in FIG. 6A, the control packet group includes a plurality of control packets, each control packet including a slot ID, data representing reservation, and communication path information. A leading control packet of the control packet group further includes data representing a start of the control packet group, and a trailing control packet of the control packet group includes data representing an end of the control packet group. The control packet group is prepared in alignment with the data packet group that is to be transmitted during a constant period one frame later. For example, the upper limit and the lower limit of the length of the data packet group are determined, and the length of the data packet group may be determined in view of an amount of the data packets to be transmitted. Alternatively, a default length of the data packet group is determined, and the default length may be used. As illustrated in FIG. 6B, the data packet group includes a control packet including a slot ID and data representing a start of the data packet group, at least one data packet, and a control packet including a slot ID and data representing an end of the data packet group. The control packet group is transmitted to verify that no packet collision occurs in a relay node in a communication path to a destination edge node, followed by the transmission of the data packet group. The period throughout which it is guaranteed that no packet collision occurs is the transmission period specified by the control packet group in a preceding frame. The data packet group having the same length as that of the control packet group is periodically transmitted in order to maintain the reserved state during the period. For example, even if a queue becomes temporarily empty, the reserved state may be maintained by periodically transmitting the data packet group including null packets. With this arrangement, the system is free from transmitting the control packet group again even if the queue is loaded with a new data packet.

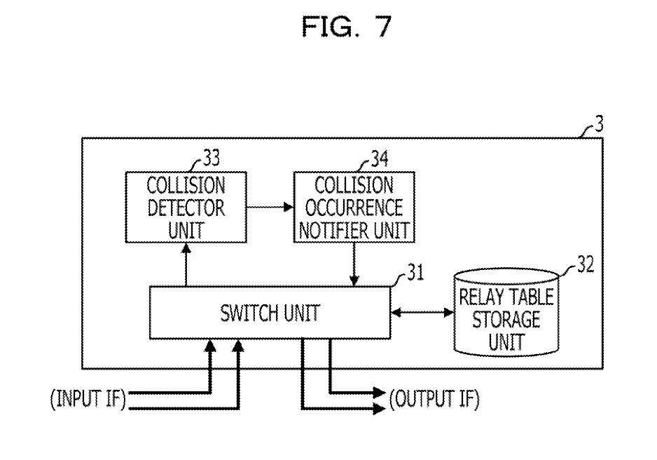

FIG. 7 is a function block diagram of the relay router 3 of FIG. 1. The relay router 3 includes switch unit 31, relay table storage unit 32, collision detector unit 33, and collision occurrence notifier unit 34. The relay router 3 includes no buffer for data packet, and relays the data packet group in a bufferless fashion.

The switch unit 31, connected to a plurality of IFs, registers data in the relay table storage unit 32 in response to the reception of the control packet group, and switches IFs in accordance with data stored on the relay table storage unit 32. The collision detector unit 33 monitors the packets flowing through the IFs to detect a collision. A collision occurs, for example, when an input IF receives a data packet group or a control packet group, another control packet group having the same output IF as the output IF of the data packet group or the control packet group is received by another input IF. If the collision detector unit 33 detects a collision, the collision occurrence notifier unit 34 calculates adjustment time, and then transmits a collision occurrence notification including the adjustment time to a transmission source edge node.

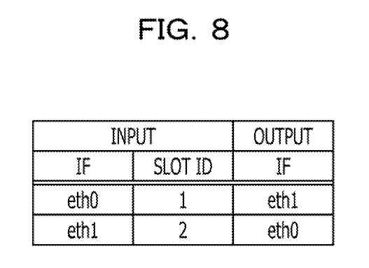

The relay table storage unit 32 stores a relay table of FIG. 8. As illustrated in FIG. 8, the relay table includes an input (INPUT) column, and an output (OUTPUT) column. The input column lists identification information of the IF receiving the packet, and a slot ID. The output column lists identification information of the IF serving as an output destination of the packet. For example, slot 1 is set in the leading packet, and the data packet group input from the IF of eth0 is output to the IF of eth1.

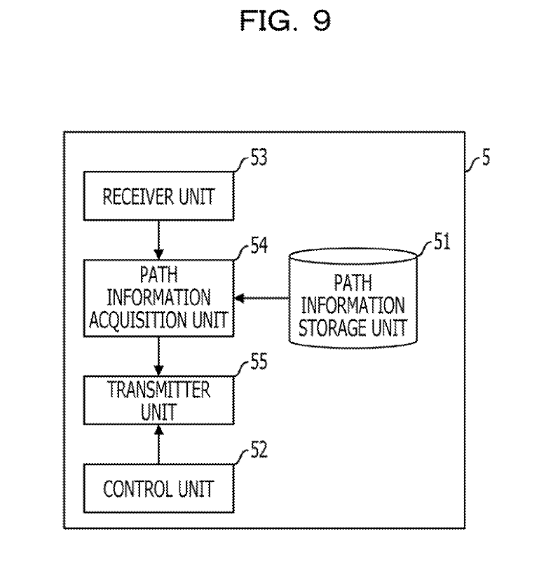

FIG. 9 is a function block diagram of the management server 5 of FIG. 1. The management server 5 includes path information storage unit 51, control unit 52, receiver unit 53, path information acquisition unit 54, and transmitter unit 55. For each combination of a transmission source edge node and a destination edge node, the path information storage unit 51 pre-stores the communication path information. The communication path information includes identification information of nodes on the shortest path from the transmission source edge node to the destination edge node and identification information of an input-output IF to be used by each node. At the startup of the management server 5, the control unit 52 instructs the transmitter unit 55 to transmit the data representing the frame length to each edge node. Upon receiving from an edge node a query about the communication path from the transmission source edge node to the destination edge node, the receiver unit 53 outputs the query to the path information acquisition unit 54. The path information acquisition unit 54 retrieves from the path information storage unit 51 the communication path information corresponding to the transmission source edge node to the destination edge node responsive to the query, and instructs the transmitter unit 55 to transmit the retrieved communication path information to a transmission source that has originated the query. The transmitter unit 55 transmits the data in response to the instruction from one of the control unit 52 and the path information acquisition unit 54.

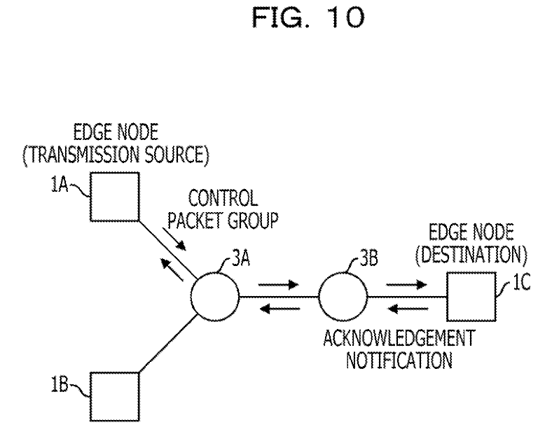

The process flow of the transmission reservation of the data packet is described below with reference to FIGS. 10-12. In the process flow, the edge node 1A reserves a packet transmission to the edge node 1C. With reference to FIG. 10, the transmission reservation is to be completed with no collision occurring in the relay routers 3A and 3B in the communication path. The edge node 1A registers on the schedule DB 16 a new record having the edge node 1C as a destination edge node. The edge node 1A also transmits to the management server 5 a query of the communication path routed to the edge node 1C. Upon receiving the communication path information from the management server 5 as a reply to the query about the communication path, the edge node 1A sets, on an added record, the received communication path information and the identification information of an output IF identified by the communication path information. The communication path may here be “edge node 1A->relay node 3A->relay node 3B->edge node 1C.” Also set on the added record is an ID of a queue including a packet to be transmitted to the edge node 1C. The edge node 1A also allocates a new slot ID (identifier) and sets the new slot ID to the added record. The edge node 1A determines the transmission timing and the transmission time of the control packet group in accordance with the transmission enable time of own edge node, and sets the transmission timing and the transmission time on the added record, and defaults the accumulated adjustment time to zero.

The edge node 1A transmits the control packet group at the determined transmission timing. The edge node 1A sets the slot ID and the communication path information set in the added record at a control packet within the control packet group.

Upon receiving the control packet group, the relay node 3A checks that no collision occurs at which the control packet group happens to have the same output IF as the output IF of the data packet group or another control packet group. It is assumed here that no collision takes place. The relay node 3A sets in the relay table the identification information of the input IF, and the identification information of the output IF identified by the slot ID and the communication path information included in the control packet, and then outputs the control packet group to the output IF. Similarly, upon receiving the control packet group, the relay node 3B checks that no collision occurs at which the control packet group happens to have the same output IF as the output IF of the data packet group or another control packet group. It is assumed here that no collision occurs. The relay node 3B sets in the relay table the identification information of the input IF, and the identification information of the output IF identified by the slot ID and the communication path information included in the control packet, and then outputs the control packet group to the output IF.

Upon receiving the leading packet of the control packet group, the edge node 1C transmits to the edge node 1A an acknowledgement signal (hereinafter referred to as acknowledgement notification) as a reply to the control packet group. The relay nodes 3A and 3B are switched until the trailing packet of the control packet group has been received such that the packets flow between the edge node 1A and the edge node 1C. The edge node 1A may thus receive the acknowledgement notification from the edge node 1C within the time of the control slot.

If no collision occurs in the relay nodes 3A and 3B, the acknowledgement notification returns to the edge node 1A from the edge node 1C as a reply to the control packet group. The fact that the acknowledgement notification has been received indicates the completion of the transmission reservation of the data packet. The data packet group can be transmitted at the transmission timing one frame later. Since the slot ID and the identification information of the input-output IFs are registered in the relay table of each of the relay nodes 3A and 3B, the data packet is appropriately transmitted from the edge node 1A to the edge node 1C.

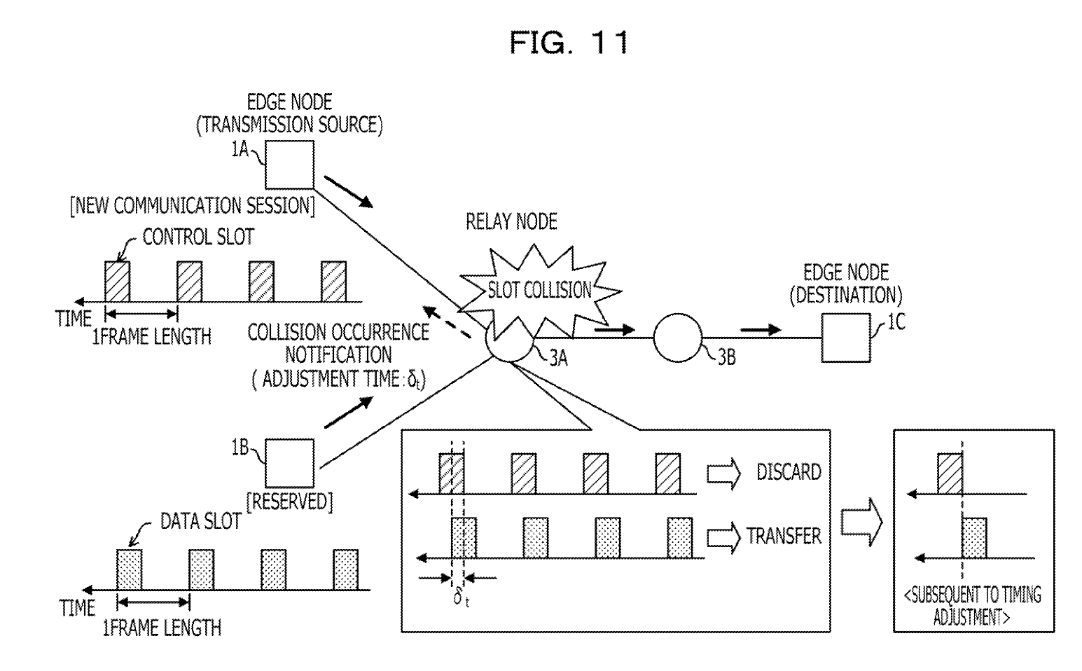

Referring to FIG. 11, a collision occurring in the relay node 3A in the communication path is discussed. FIG. 11 is based on the premise that a collision occurs at which the edge node 1A transmits the control packet group to the edge node 1C when the edge node 1B transmits the data packet group to the edge node 1C. The reservation of the communication between the edge node 1B and the edge node 1C is complete prior to the collision.

The edge node 1A transmits the control packet group to the edge node 1C in the process described above. The relay node 3A receives the control packet group from the edge node 1A while relaying the data packet group from the edge node 1B. The relay node 3A then detects the occurrence of the collision, and discards the received control packet group. On the other hand, the relay node 3A continues to transfer the data packet group from the edge node 1B in a bufferless fashion. The relay node 3A calculates the adjustment time δt from the reception start of the leading packet of the control packet group to the reception end of the trailing packet of the control packet group, and transmits a collision signal including the adjustment time (hereinafter also referred to as a collision occurrence notification) to the edge node 1A.

The edge node 1A receives from the relay node 3A the collision occurrence notification including the adjustment time δt within the time of the control slot. The edge node 1A calculates a new transmission timing into which the transmission timing of the control packet group is shifted later by the adjustment time δt, sets the new transmission timing in the corresponding record within the schedule DB 16, and adds the adjustment time δt to the accumulated adjustment time in the record. The edge node 1A determines whether the accumulated adjustment time is shorter than the frame length. If the accumulated adjustment time is shorter than the frame length, the edge node 1A retransmits the control packet group to the edge node 1C at the new transmission timing.

By adjusting the transmission timing, the relay node 3A receives the control packet group from the edge node 1A after the reception of the data packet group from the edge node 1B. The control packet group does not collide with the data packet group from the edge node 1B. The relay node 3A receives the control packet group, checks that no collision occurs, sets in the relay table the identification information of the input IF, and the identification information of the output IF identified by the slot ID and the communication path information included in the control packet, and then outputs the control packet group to the output IF. If no collision occurs in the relay node 3B thereafter, the edge node 1A receives the acknowledgement notification from the edge node 1C and completes the transmission reservation of the data packet as described above.

By shifting the transmission timing by the adjustment time δt, the collision described is prevented. There is a possibility that a new collision occurs in another relay node in the communication path. If a new collision occurs in another relay node, the transmission timing is further adjusted using the adjustment time included in the collision occurrence notification transmitted from the other relay node. The control packet group is simply retransmitted at the adjusted transmission timing. If the accumulated adjustment time becomes equal to or longer than the frame length, there is no slot that permits communication to be performed without collision in view of communication status of the other edge nodes. In such a case, the process ends. If slots become available depending on the communication status, the transmission source edge node defaults the accumulated adjustment time to zero after a constant period of time has elapsed, and the transmission reservation of the data packet may be performed again.

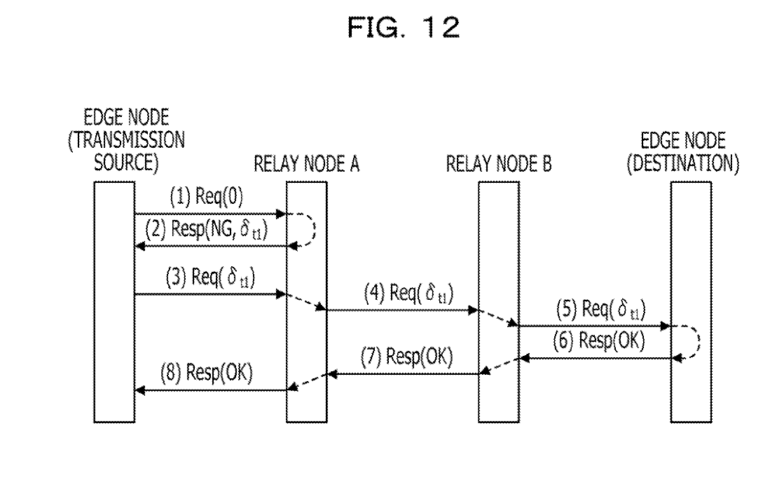

FIG. 12 illustrates a sequence example performed when a collision occurs. The transmission source edge node transmits the control packet group to the destination edge node at time 0 (i.e., at the frame start time) (operation (1) in FIG. 12). Label “Req” of FIG. 12 represents the leading packet of the control packet group. Numbers in parentheses refer to the transmission timing. A collision occurs in the relay node A here. The relay node A transmits the collision occurrence notification including the adjustment time δt1 to the transmission source edge node (operation (2)). Label “Resp(NG,δt1)” represents the collision occurrence notification including the adjustment time δt1.

Upon receiving the collision occurrence notification including the adjustment time δt1 from the relay node A within the time of the control slot, the transmission source edge node calculates a new transmission timing using the adjustment time δt1. Since the transmission timing is time 0, δt1 becomes a new transmission timing. The transmission source edge node retransmits the control packet group to the destination edge node at time δt1 (operation (3)).

Upon receiving the control packet group from the transmission source edge node, the relay node A checks that no collision has occurred, and transfers the control packet group to the relay node B (operation (4)). Upon receiving the control packet group from the relay node A, the relay node B checks that no collision has occurred, and transfers the control packet group to the destination edge node (operation (5)).

Upon receiving the leading packet of the control packet group, the destination edge node transmits the acknowledgement notification to the transmission source edge node (operation (6)). Label “Resp(OK)” means the acknowledgement notification. In response to the acknowledgement notification from the destination edge node, the relay node B transfers the acknowledgement notification to the relay node A (operation (7)). Upon receiving the acknowledgement notification from the relay node B, the relay node A transfers the acknowledgement notification to the transmission source edge node (operation (8)). Within the time of the control slot, the transmission source edge node receives the acknowledgement notification from the destination edge node and the transmission reservation of the data packet is complete.

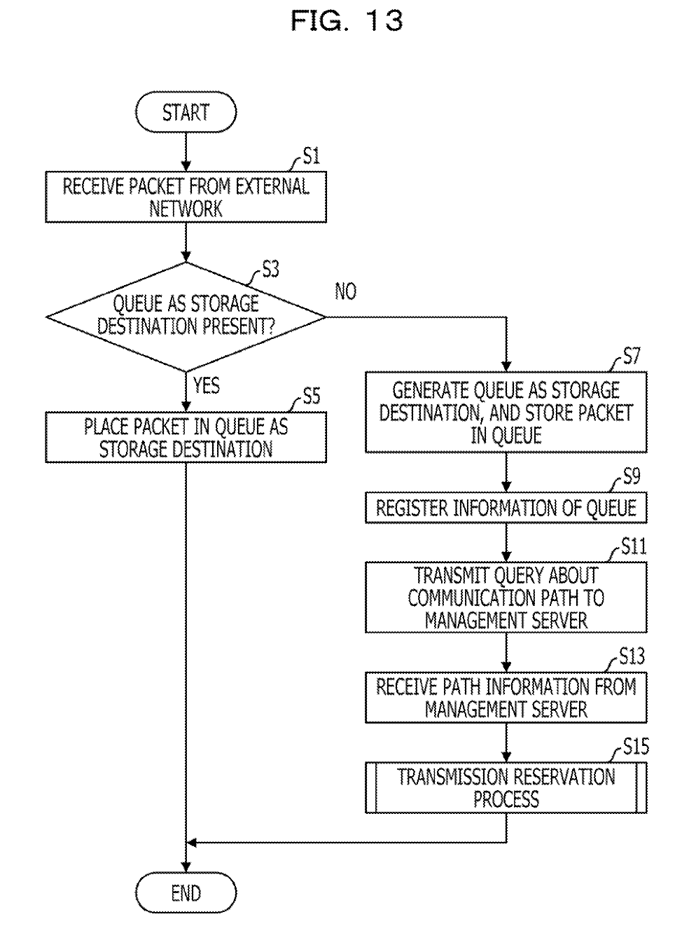

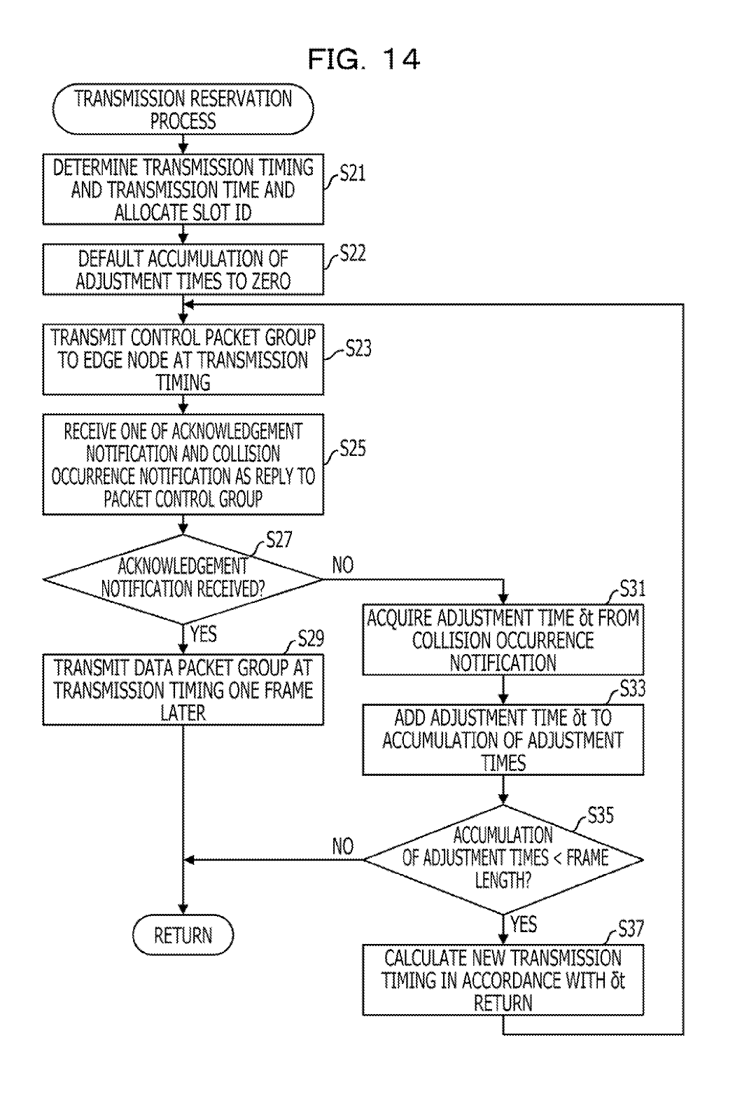

The process of the network system of FIG. 1 is described in detail with reference to FIGS. 13-21. The process of the edge router 1 performed when a packet is received from the external network is described first with reference to FIGS. 13 and 14. The packet receiver unit 11 receives the packet from the external network via the communication unit 19 (51 of FIG. 13), and then outputs the packet to the packet sorter unit 12. Upon receiving the packet from the packet receiver unit 11, the packet sorter unit 12 determines whether the queue 121 serving as a storage destination is present (S3). More specifically, the packet sorter unit 12 acquires a destination IP address from an IP header of the received packet, and searches a destination node table stored on the destination node table storage unit 13 for the destination IP address to identify the destination edge node. The packet sorter unit 12 then searches a queue management table stored on the queue management table storage unit 14 for the identifier of the identified destination edge node. If the identifier of the identified destination edge node is registered in the queue management table, the packet sorter unit 12 determines that the queue 121 serving as the storage destination is present. The queue 121 having a queue ID stored in the queue management table and mapped to the identifier of the identified destination edge node serves as the storage destination. If the identifier of the identified destination edge node is not registered in the queue management table, the packet sorter unit 12 determines that the queue 121 serving as the storage destination is not present. If it is determined that the queue 121 serving as the storage destination is present (yes loop from S3), the packet sorter unit 12 stores the packet in the queue 121 serving as the storage destination (S5). Processing thus ends. The scheduler unit 15 transmits the packet stored in the queue 121 to the destination edge node in accordance with data stored on the schedule DB 16.

If it is determined that the queue 121 serving as the storage destination is not present (no loop from S3), the packet sorter unit 12 generates the queue 121 serving as the storage destination and stores the packet in the queue 121 (S7). The packet sorter unit 12 registers in the queue management table of the queue management table storage unit 14 a new record including a queue ID identifying the generated queue 121 and an identifier of the destination edge node (S9). The packet sorter unit 12 instructs the scheduler unit 15 to perform the transmission reservation of the packet stored on the generated queue 121. In this case, the packet sorter unit 12 outputs to the scheduler unit 15 the queue ID of the generated queue 121 and the identifier of the destination edge node.

The scheduler unit 15 receives the queue ID and the identification information of the destination edge node together with the instruction to perform the transmission reservation from the packet sorter unit 12. The scheduler unit 15 then adds a new record (hereinafter referred to as a reservation target record) to the schedule DB 16, and sets the queue ID and the identification information of the destination edge node in the reservation target record. The scheduler unit 15 transmits to the management server 5 a query about the communication path to the destination edge node via the control line (S11). The query includes the identification information of the transmission source edge node (i.e., the identification information of own edge node), and the identification information of the destination edge node. The scheduler unit 15 receives the communication path information from the management server 5 as a reply to the query about the communication path (S13). The scheduler unit 15 sets the received communication path information in the reservation target record on the schedule DB 16. The scheduler unit 15 also sets the identification information of the IF, which is to receive the packet, in the reservation target record on the schedule DB 16. The communication path information identifies which IF to output the packet to. The scheduler unit 15, the transmission timing calculator unit 17, and the reply signal receiver unit 18 perform a transmission reservation process using the reservation target record on the schedule DB 16 (S15). Processing thus ends. The transmission reservation process is described below with reference to FIG. 14.

The scheduler unit 15 determines the transmission timing and the transmission time in accordance with the data stored on the schedule DB 16, and then allocates a new slot ID (S21 of FIG. 14). The scheduler unit 15 sets the transmission timing, the transmission time, and the slot ID in the reservation target record on the schedule DB 16. The scheduler unit 15 defaults the value of the accumulated adjustment time in the reservation target record to zero (S22). The scheduler unit 15 transmits the control packet group illustrated in FIG. 6A at the determined transmission timing in accordance with the data set in the reservation target record on the schedule DB 16 (S23). More specifically, the scheduler unit 15 sets in the control packet the slot ID and the communication path information set in the reservation target record and the data representing reservation, and outputs the control packet group including the control packet to the output IF set in the reservation target record.

The reply signal receiver unit 18 receives one of the acknowledgement notification and the collision occurrence notification as a reply to the control packet group (S25), and outputs the received notification to the transmission timing calculator unit 17. If no collision occurs in any of the relay nodes in the communication path, the reply signal receiver unit 18 receives the acknowledgement notification from the destination edge node as a reply to the control packet group. If a collision occurs in one of the relay nodes in the communication path, the reply signal receiver unit 18 receives the collision occurrence notification from the relay node suffering from the collision as a reply to the control packet group. Upon receiving the acknowledgement notification from the reply signal receiver unit 18 (yes loop from S27), the transmission timing calculator unit 17 sets “reservation completed” in the column of the accumulated adjustment time in the reservation target record on the schedule DB 16. The scheduler unit 15 then transmits the data packet group to the destination edge node at the transmission timing one frame later (S29). Processing completes the process then returns to the preceding process.

Upon receiving the collision occurrence notification from the reply signal receiver unit 18 (no loop from S27), the transmission timing calculator unit 17 acquires the adjustment time δt from the collision occurrence notification (S31). The transmission timing calculator unit 17 adds the acquired adjustment time δt to the value of the accumulated adjustment time at the reservation target record on the schedule DB 16 (S33), and determines whether the accumulated adjustment time is shorter than the frame length (S35). If the accumulated adjustment time is equal to or longer than the frame length (no loop from S35), processing completes the process, and then returns to the preceding process. The value of the accumulated adjustment time equal to or longer than the frame length means that there is no slot that permits communication to be performed without collision in view of communication status of the other edge nodes.

If the accumulated adjustment time is shorter than the frame length (yes loop from S35), the transmission timing calculator unit 17 calculates a new timing into which the transmission timing set in the reservation target record on the schedule DB 16 is shifted later by the adjustment time δt, and sets the new transmission timing on the reservation target record (S37). Processing then returns to S23. In S23, the scheduler unit 15 retransmits the control packet group at the new transmission timing.

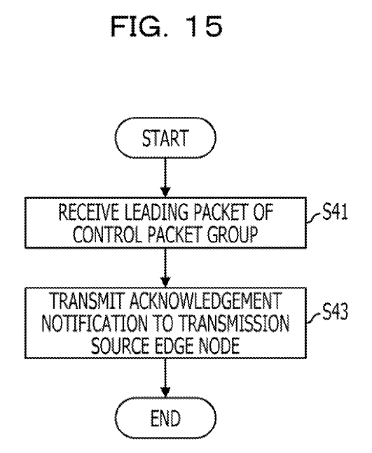

A process of the edge router 1 performed when the control packet group is received from the transmission source edge node is described with reference to FIG. 15. Upon receiving the leading packet of the control packet group from the transmission source edge node via the communication unit 19 (S41 of FIG. 15), the scheduler unit 15 transmits the acknowledgement notification to the transmission source edge node (S43). The relay node in the communication path is switched until the reception of the trailing packet of the control packet group such that the packets flow between the own edge node and the transmission source edge node. The transmission source edge node then receives the acknowledgement notification within the time of the control slot.

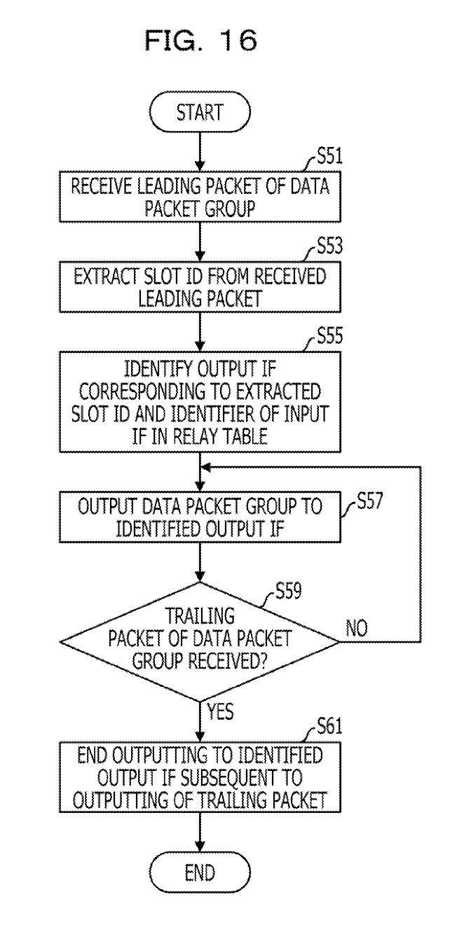

FIG. 16 illustrates a process of the relay router 3 in the reception of the data packet group. When an input IF receives a leading packet of the data packet group (S51 of FIG. 16), the switch unit 31 extracts the slot ID from the received leading packet (S53). The switch unit 31 then identifies, in the relay table stored on the relay table storage unit 32, an output IF corresponding to the extracted slot ID and the identification information of the input IF (S55). The switch unit 31 then outputs the data packet group to the identified output IF (S57). The switch unit 31 then determines whether a trailing packet of the data packet group has been received (S59). If the trailing packet of the data packet group has not been received (no loop from S59), processing returns to S57. The data packet group is continuously output to the identified output IF.

When the trailing packet of the data packet group has been received (yes loop from S59), the switch unit 31 completes outputting to the output IF after outputting the trailing packet to the identified output IF (S61). Processing thus ends.

The transmission source edge node uses the control packet group to determine whether a collision is to occur, and transmits the data packet group at a timing free from collision. Since no collision occurs between the data packet groups at the relay node, the data packet group is relayed in a bufferless fashion.

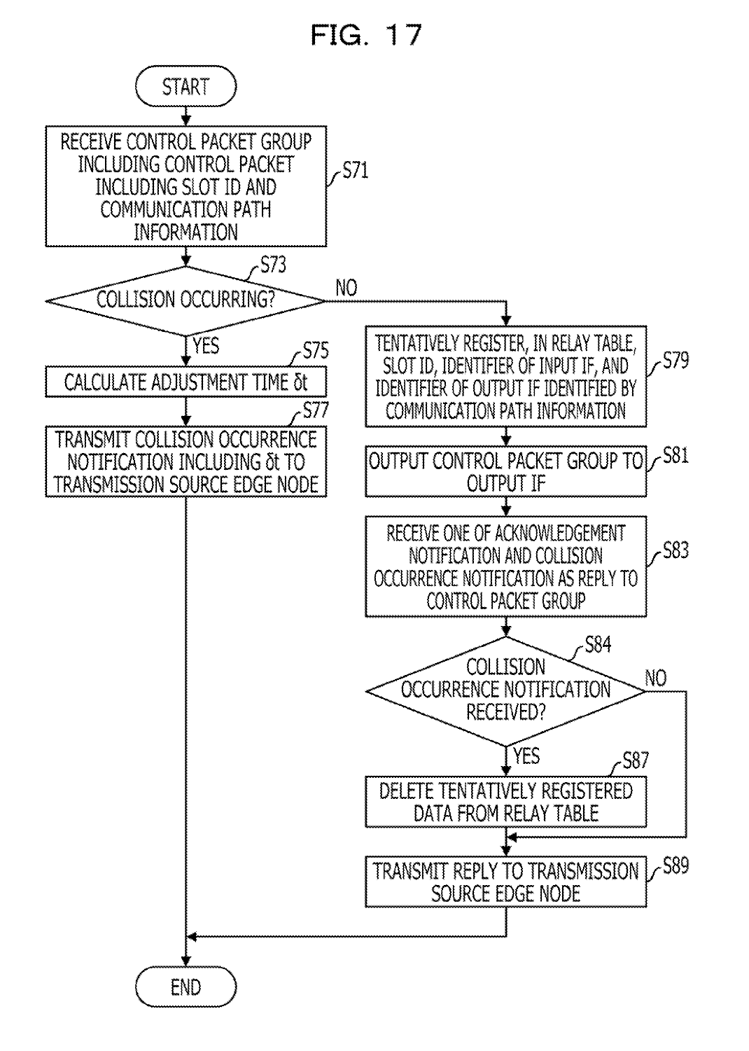

FIG. 17 illustrates a process of the relay router 3 in the reception of the control packet group. The switch unit 31 first receives the control packet group including the control packet. The control packet includes the slot ID and the communication path information (S71 of FIG. 17). The reception start time of the leading packet of the control packet group is stored in a storage unit. The collision detector unit 33 determines whether a collision occurs (S73). At a collision, the output destination of the control packet group collides with the output destination of one of the data packet group and another control packet group. If a collision is detected (yes loop from S73), the collision occurrence notifier unit 34 calculates the adjustment time δt from the reception start of the leading packet of the control packet group to the reception end of the trailing packet of the data packet group (S75). For example, the reception end time of the trailing packet of the data packet group is stored in the storage unit. The collision occurrence notifier unit 34 calculates the adjustment time δt from the reception start time of the leading packet of the control packet group to the reception end time of the trailing packet of the data packet group stored on the storage unit. Alternatively, a timer (not illustrated) may be started at the reception start time of the leading packet of the control packet group and count time until the reception end time of the trailing packet of the data packet group. If the control packet groups collide with each other, the collision occurrence notifier unit 34 calculates as the adjustment time δt the time from the reception end of the trailing packet of the preceding control packet group to the reception start of the leading packet of the subsequent control packet group. The collision occurrence notifier unit 34 then transmits the collision occurrence notification including the adjustment time δt to the transmission source edge node (S77). If the collision occurs, the control packet group (the later received control packet group if the control packet groups collide with each other) is discarded. Processing thus ends.

If no collision is detected (no loop from S73), the switch unit 31 tentatively registers in the relay table the slot ID, the identification information of the input IF, and the identification information of the output IF identified by the communication path information (S79). Since there is a possibility that a collision occurs in another relay node in the communication path, the tentative registration is performed. The switch unit 31 outputs the received control packet group to the output IF (S81).

The switch unit 31 receives one of the acknowledgement notification and the collision occurrence notification as a reply to the control packet group (S83). If no collision occurs in any of the relay nodes in the communication path, the switch unit 31 receives the acknowledgement notification from the destination edge node as a reply to the control packet group. If a collision occurs in a relay node in the communication path, the switch unit 31 receives the collision occurrence notification from the relay node suffering from the collision as a reply to the control packet group. If the notification received in S83 is a collision occurrence notification (yes loop from S85), the switch unit 31 deletes the data tentatively registered in the relay table in S79 (S87). Processing proceeds to S89.

If the notification received in S83 is an acknowledgement notification (no loop from S85), processing proceeds to S89. In such a case, the data tentatively registered in S79 is considered as final, and used to relay an incoming data packet group.

The switch unit 31 transmits one of the acknowledgement notification and the collision occurrence notification received in S83 to the transmission source edge node (S89). Process thus ends.

Through the above-described process, the transmission source edge node is notified of the collision occurrence notification including the adjustment time if a collision occurs. The transmission source edge node may appropriately adjust the transmission timing. Since the slot ID and the identification information of the input and output IFs are registered in the relay table, the data packet group coming in thereafter is relayed in a bufferless fashion.

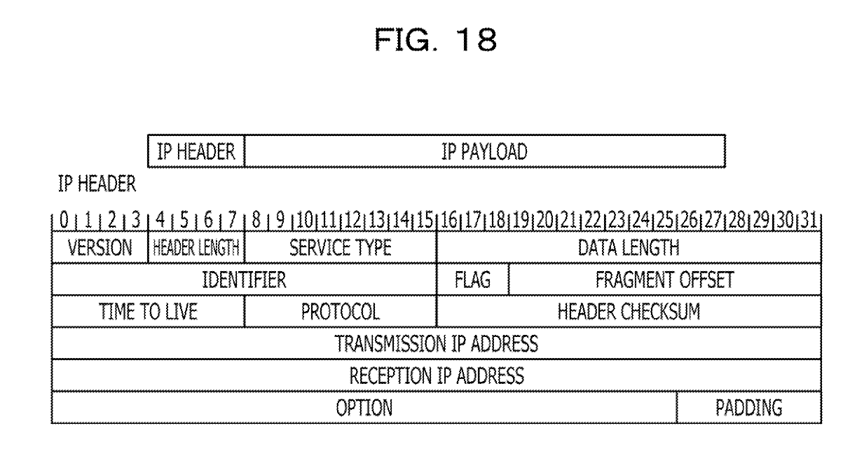

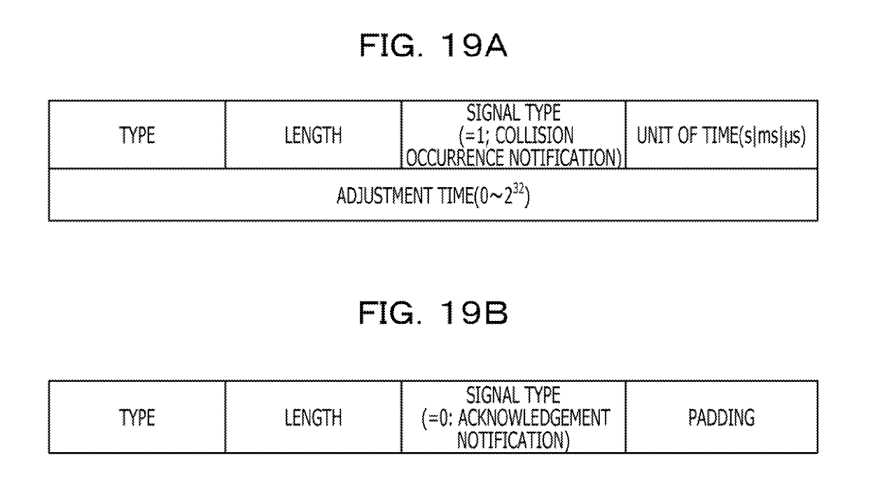

An option field included the IP header of the IP packet may be used for the collision occurrence notification and the acknowledgement notification. FIG. 18 diagrammatically illustrates the IP packet and the IP header. The IP header is known and is only briefly discussed here. The IP header includes a transmission IP address, a reception IP address, and option fields. For the collision occurrence notification, data of FIG. 19A is set in option fields. In FIG. 19A, the option fields include “type,” “length,” “signal type,” “unit of time,” and “adjustment time.” A new code representing that the content of the fields is “collision/acknowledgement signal” is prepared. The new code is then set in the “type” field. The data length (unit: byte) of the option field is set in the “length” field. Set in the “signal type” field is 1 (=the collision occurrence notification).

The “unit of time” field represents a unit of time of the adjustment time (0: s, 1: ms, and 2: μs). The “adjustment time” field represents a time value falling within a range of 0-2³².

For the acknowledgement notification, data is set in option fields of FIG. 19B. As illustrated in FIG. 19B, the option field includes “type,” “length,” “signal type,” and “padding” fields. The “type” and “length” fields remain unchanged from those in the collision occurrence notification. Set in the “signal type” field is 0 (=the acknowledgement notification) in the acknowledgement notification.

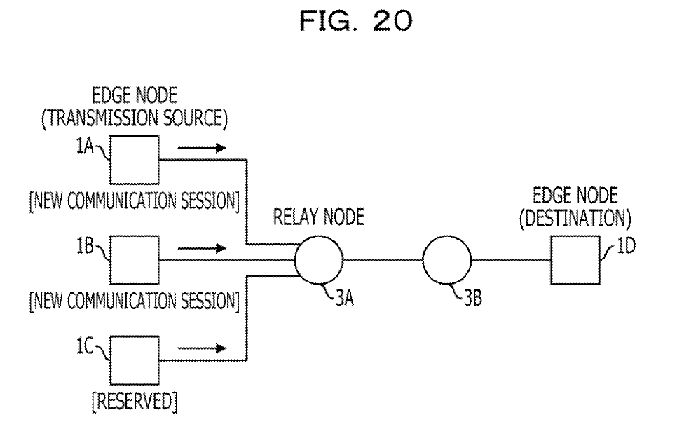

In the network configuration described above, the relay nodes are connected to two edge nodes. The edge node may be connected to three or more edge nodes. FIG. 20 illustrates a network configuration including relay nodes connected to three edge nodes. As illustrated in FIG. 20, the relay node 3A is connected to an edge node 1A, an edge node 1B, an edge node 1C, and a relay node 3B. The relay node 3B is connected an edge node 1D. In FIG. 20, communications between the edge node 1C and the edge node 1D are pre-reserved, and the edge node 1A and the edge node 1B are to transmit the control packet group to the edge node 1C.

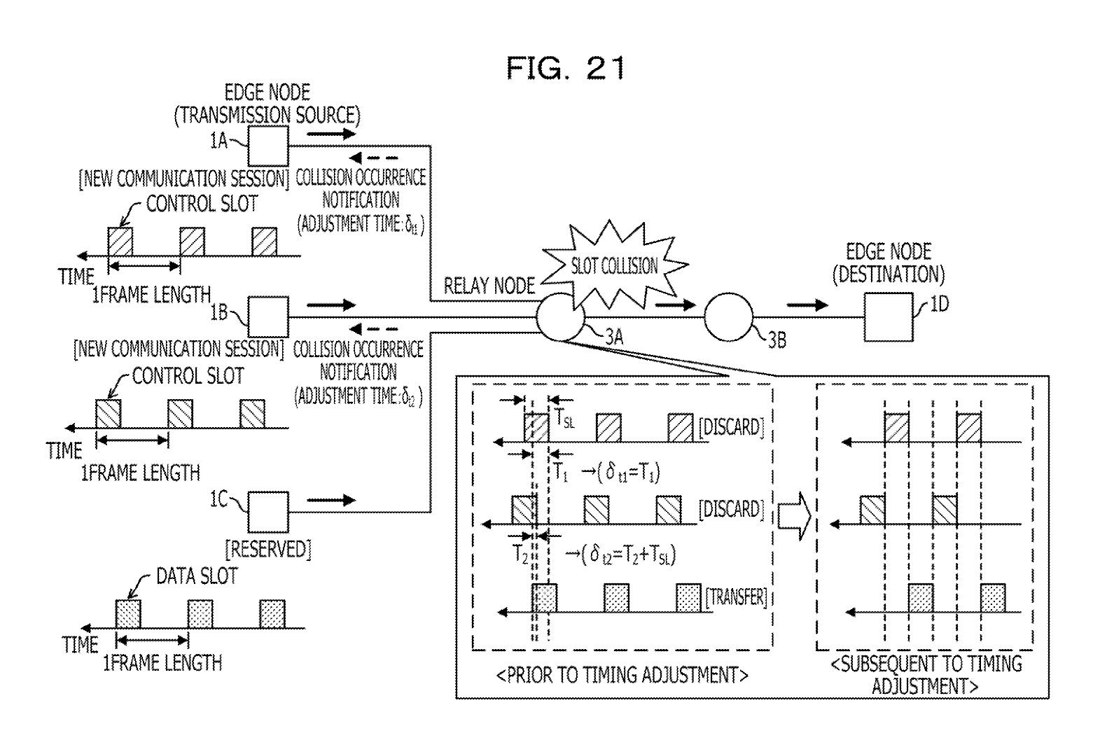

A collision may now occur in the relay node 3A as illustrated in FIG. 21. FIG. 21 illustrates that the relay node 3A receives a control packet group from the edge node 1A and a control packet group from the edge node 1B while receiving a data packet group from the edge node 1C. The relay node 3A calculates time T₁ (=δt1) of the earlier received control packet group (the control packet group from the edge node 1A in FIG. 21) out of the control packet groups from the edge nodes 1A and 1B. Time T₁ is time from the reception start of the leading packet of the control packet group to the reception end of the trailing packet of the data packet group from the edge node 1A. The relay node 3A then transmits the collision occurrence notification including the adjustment time δt1 to the edge node 1A.

The relay node 3A calculates time T₂ of the later received control packet group (the control packet group from the edge node 1B in FIG. 21) in S75. Time T₂ is time from the reception start of the leading packet of the control packet group to the reception end of the trailing packet of the data packet group from the edge node 1B. The relay node 3A then sums T₂ and a length T_{SL} of the control packet group from the edge node 1A and sets the sum as the adjustment time δt2. If T₂ is the adjustment time δt2, the control packet groups retransmitted from the edge node 1A and the edge node 1B at the adjusted transmission timings are to collide with each other. The collision occurrence notification including the adjustment time δt2 is then transmitted to the edge node 1B.

### Second Embodiment

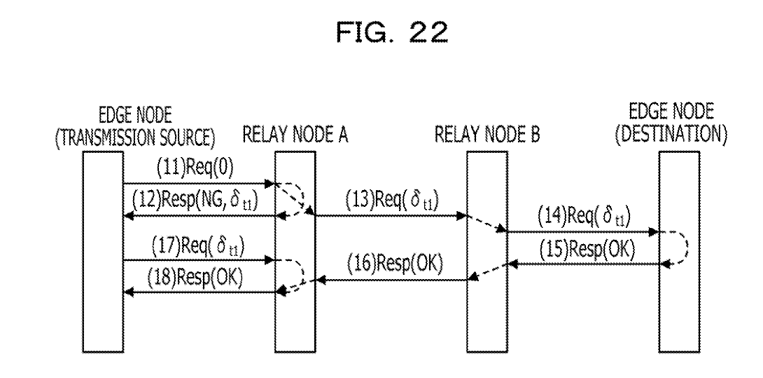

The second embodiment is described below with reference to FIGS. 22-26. In the embodiment, a relay node transmits a collision occurrence notification to a transmission source edge node and transmits a control packet group to a next relay node after the reception end of a trailing packet of a data packet group. This arrangement checks whether communication is possible at a timing shifted by an adjustment time.

FIG. 22 illustrates a sequence example of the embodiment. The sequence of FIG. 22 is performed at the occurrence of a collision. The transmission source edge node transmits the control packet group to the destination edge node at time zero (i.e., at the frame start time) (operation (11) of FIG. 22). Label “Req” of FIG. 22 represents the leading packet of the control packet group. Numbers in parentheses refer to the transmission timing. A collision occurs in the relay node A here. The relay node A transmits the collision occurrence notification including the adjustment time δt1 to the transmission source edge node and transmits the control packet group to the relay node B at timing shifted by the adjustment time δt1 (operations (12) and (13)). In FIG. 22, the control packet group is transmitted from the transmission source edge node at time 0, and the control packet group is transmitted from the relay node A at time δt1 within the same frame. Label “Resp(NG,δt1)” represents the collision occurrence notification including the adjustment time δt1.

Upon receiving the control packet group from the relay node A, the relay node B checks that no collision has occurred, and transmits the control packet group to the destination edge node (operation (14)). Upon receiving the leading packet of the control packet group, the destination edge node transmits the acknowledgement notification to the transmission source edge node (operation (15)). Label “Resp(OK)” represents the acknowledgement notification. Upon receiving the acknowledgement notification from the destination edge node, the relay node B transmits the acknowledgement notification to the relay node A (operation (16)).

Upon receiving the collision occurrence notification including the adjustment time δt1 from the relay node A within the time of the control slot, the transmission source edge node calculates a new transmission timing using the adjustment time δt1. Since the transmission timing is time 0, δt1 becomes a new transmission timing. The transmission source edge node retransmits the control packet group to the destination edge node at time δt1 (operation (17)). Upon receiving the control packet group from the transmission source edge node and the acknowledgement notification from the relay node B, the relay node A transmits the acknowledgement notification to the transmission source edge node (operation (18)). The transmission source edge node receives the acknowledgement notification from the destination edge node within the time of the control slot, and the transmission reservation of the data packet is thus complete.

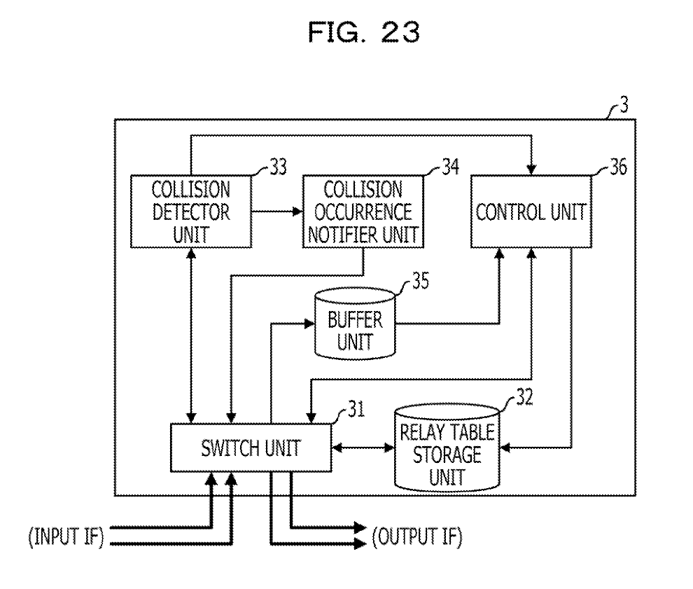

FIG. 23 is a function block diagram of the relay router 3 of the embodiment. The embodiment is based on the premise that the relay router 3 is used in the network system 100 of FIG. 1. The function block diagrams of the edge router 1 and the management server 5 remain identical to those of the first embodiment.

The relay router 3 of the embodiment includes switch unit 31, relay table storage unit 32, collision detector unit 33, collision occurrence notifier unit 34, buffer unit 35, and control unit 36. The switch unit 31, the relay table storage unit 32, the collision detector unit 33, and the collision occurrence notifier unit 34 are basically identical to the counterparts thereof in the first embodiment. In the embodiment, the switch unit 31 makes a copy of the received control packet group and then temporarily stores the copy on the buffer unit 35. Upon detecting a collision, the collision detector unit 33 notifies the control unit 36 of the occurrence of the collision. Upon receiving a collision occurrence notification from the collision detector unit 33, the control unit 36 outputs the control packet group temporarily stored on the buffer unit 35 to the output IF via the switch unit 31 after the reception end of the trailing packet of the data packet group.

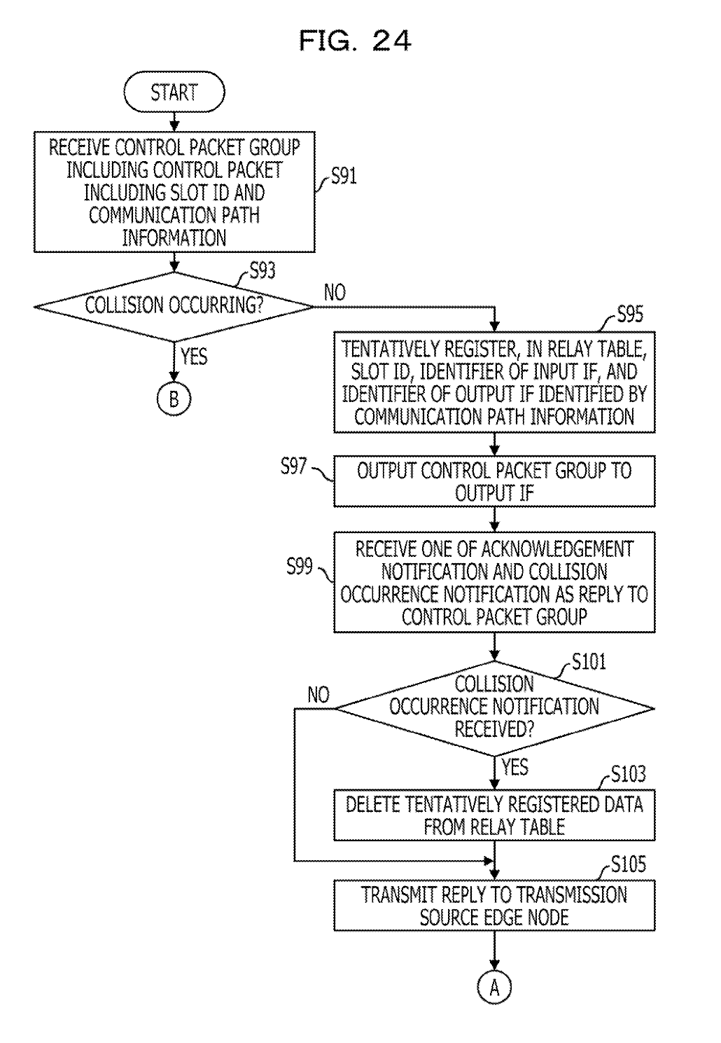

Referring to FIGS. 24-26, a process of the relay router 3 in the reception of the control packet group is described. The other processes are basically identical to those in the first embodiment. The switch unit 31 first receives the control packet group including the control packet, the control packet including the slot ID and the communication path information (S91 of FIG. 24). The reception start time of the leading packet of the control packet group is stored in a storage unit. The switch unit 31 makes a copy of the received control packet group and then stores the copy in the buffer unit 35. The collision detector unit 33 determines whether a collision has occurred (S93). At a collision, the output destination of the control packet group collides with the output destination of one of the data packet group and another control packet group. If no collision is detected (no loop from S93), the switch unit 31 tentatively registers in the relay table the slot ID, the identification information of the input IF, and the identification information of the output IF identified by the communication path information (S95). The switch unit 31 outputs the received control packet group to the output IF (S97).

The switch unit 31 receives one of the acknowledgement notification and the collision occurrence notification as a reply to the control packet group output in S97 (S99). If no collision occurs in any of the relay nodes in the communication path, the switch unit 31 receives the acknowledgement notification from the destination edge node as a reply to the control packet group. If a collision occurs in a relay node in the communication path, the switch unit 31 receives the collision occurrence notification from the relay node suffering from the collision as a reply to the control packet group. If the notification received in S99 is a collision occurrence notification (yes loop from S101), the switch unit 31 deletes the data tentatively registered in the relay table in S95 (S103). Processing then proceeds to S105.

If the notification received in S99 is an acknowledgement notification (no loop from S101), processing proceeds to S105. In such a case, the data tentatively registered in S95 is considered as final, and used to relay an incoming data packet group.

The switch unit 31 transmits one of the acknowledgement notification and the collision occurrence notification received in S99 to the transmission source edge node (S105).

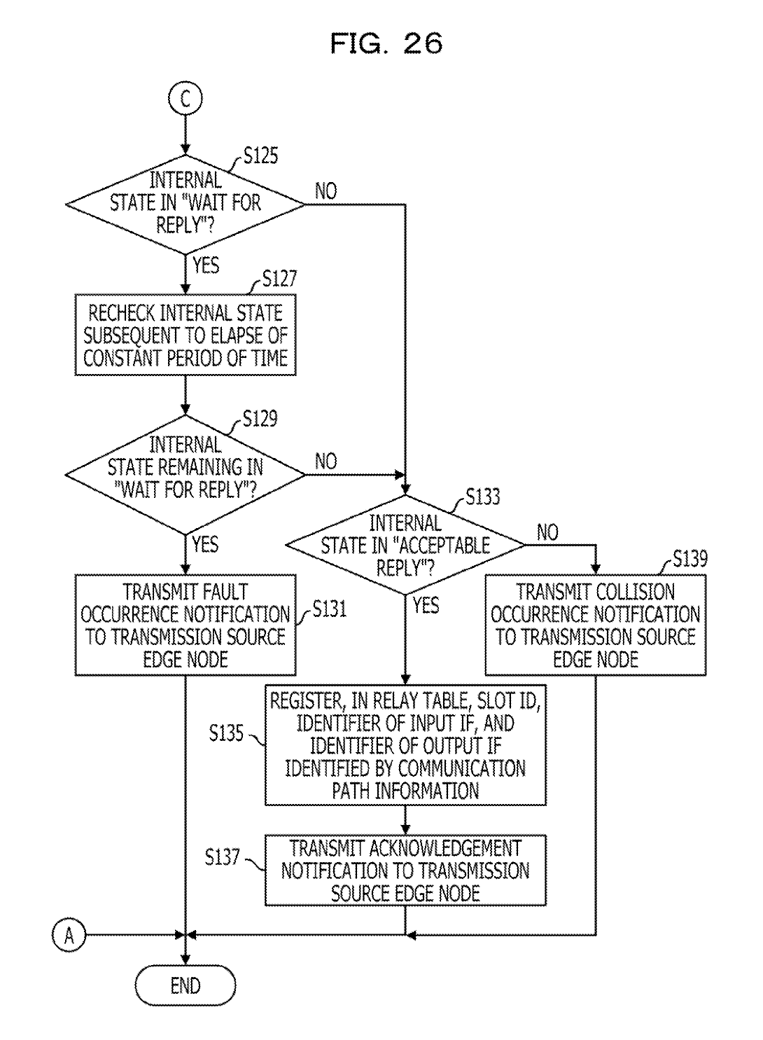

The process (operations S95-S105) performed when no collision is detected is identical to the process (operations S79-S89) in the first embodiment. Processing proceeds to a process of FIG. 26 via a point A.

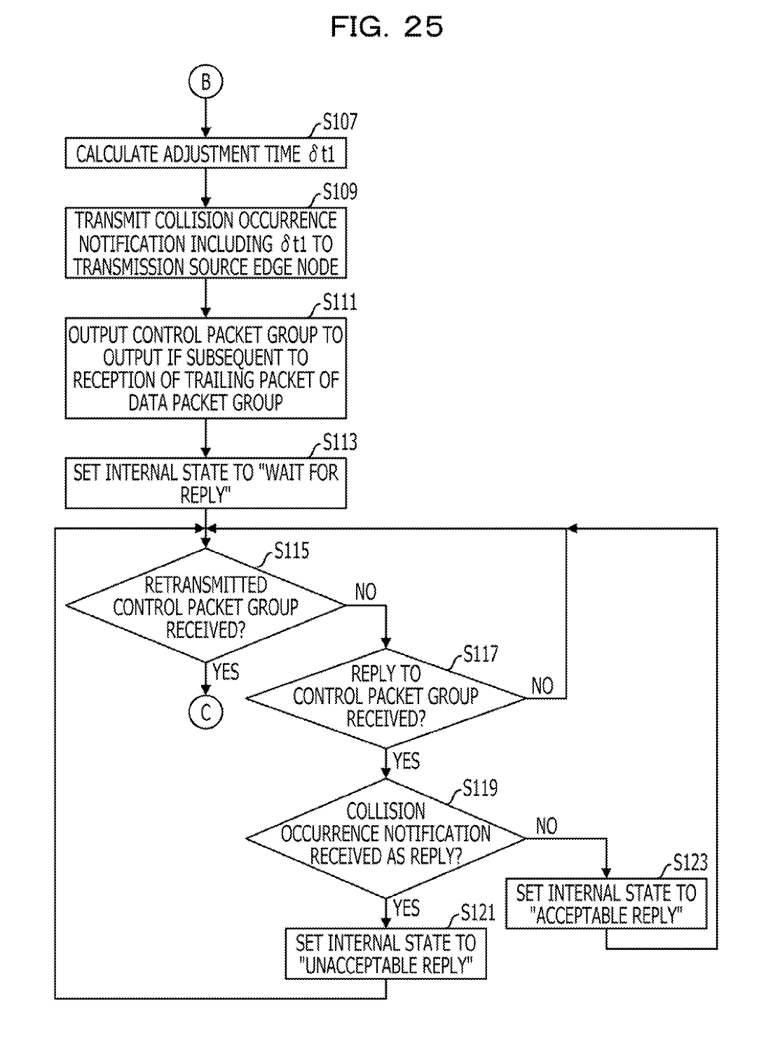

If a collision is detected (yes loop from S93), processing proceeds to a process of FIG. 25 via a point B.

Processing proceeds to the process of FIG. 25 via the point B. The collision occurrence notifier unit 34 calculates the adjustment time δt from the reception start of the leading packet of the control packet group to the reception end of the trailing packet of the data packet group (S107 of FIG. 25). The collision occurrence notifier unit 34 then transmits the collision occurrence notification including the adjustment time δt to the transmission source edge node (S109). Operations S107 and S109 are respectively identical to operations S75 and S77, and the detailed discussion thereof is omitted here.

After the reception end of the trailing packet of the colliding data packet group is received, the control unit 36 outputs the control packet group stored on the buffer unit 35 to the output IF via the switch unit 31 (S111). If the control packet groups collide with each other, the control unit 36 outputs the control packet group stored in the buffer unit 35 (i.e., the later received control packet group) to the output IF via the switch unit 31 after the reception end of the trailing packet of the earlier received control packet group. The control unit 36 sets the internal state thereof to “wait for reply” (S113).

Since the collision occurrence notification is transmitted to the transmission source edge node in S109, the control packet group retransmitted from the transmission source edge node at a new transmission timing is to be received thereafter. Since the control packet group is output to the output IF in S111, one of the acknowledgement notification and the collision occurrence notification is received as a reply to the control packet group.

The control unit 36 determines whether a control packet group retransmitted from the transmission source edge node has been received (S115). If the control unit 36 determines that a control packet group retransmitted from the transmission source edge node has been received (yes loop from S115), processing proceeds to the process of FIG. 26 via a point C.

Upon determining that the control packet group retransmitted from the transmission source edge node has not been received (no loop from S115), the control unit 36 determines whether a reply to the control packet group output in S111 (i.e., one of the acknowledgement notification and the collision occurrence notification) has been received (S117). If the control unit 36 determines that the reply to the control packet group has not been received (no loop from S117), processing returns to S115.

Upon determining that the reply to the control packet group has been received (yes loop from S117), the control unit 36 determines whether the collision occurrence notification has been received as a reply to the control packet group (S119). If it is determined that the collision occurrence notification has been received as a reply to the control packet group (yes loop from S119), the control unit 36 sets the internal state to be an “unacceptable reply” (S121). Processing then returns to S115. If it is determined that the collision occurrence notification has not been received as a reply to the control packet group (no loop from S119), the control unit 36 sets the internal state to be an “acceptable reply” (S123). Processing then returns to S115. The control unit 36 then stores in the buffer unit 35 one of the acknowledgement notification and the collision occurrence notification received.

Processing proceeds to the process of FIG. 26 via the point C. The control unit 36 then determines whether the internal state is in “wait for reply” (S125 of FIG. 26). If the reply to the control packet group output in S111 has been received, one of the operations in S121 and S123 is performed, and the internal state is thus set to be in the “unacceptable reply” or the “acceptable reply.” If the reply to the control packet group is received before step S125, the internal state should be in the “unacceptable reply” or the “acceptable reply.” If the reply to the control packet group is not received before step S125, the internal state should be in the “wait for reply.” If the internal state is not in “wait for reply” (no loop from S125), i.e., if the internal state is in the “unacceptable reply” or the “acceptable reply,” processing proceeds to S133.

If the internal state is in “wait for reply” (yes loop from S125), the control unit 36 rechecks the internal state after the elapse of the constant period (S127). If the reply to the control packet group has been received within the constant period, operations in S117-S123, although not illustrated in FIG. 26, are performed on a thread different from S127. In normal operation, the reply to the control packet group should be received within the constant period, and one of the operations in S121 and S123 sets the internal state to be in the “unacceptable reply,” or the “acceptable reply.” If the control unit 36 rechecks the internal state after the elapse of the constant period and determines that the internal state is not in the “wait for reply” (no loop from S129), processing proceeds to S133.

The control unit 36 rechecks the internal state after the elapse of the constant period. Upon determining that the internal state remains in the “wait for reply” (yes loop from S129), the control unit 36 determines that the internal state is faulty because no reply has been returned within the constant period. The control unit 36 transmits a fault occurrence notification to the transmission source edge node (S131). Processing thus ends.

In S133, the control unit 36 determines whether the internal state is in the “acceptable reply” (S133). Upon determining that the internal state is in the “acceptable reply” (yes loop from S133), the control unit 36 registers in the relay table the slot ID, the identification information of the input IF, and the identification information of the output IF identified by the communication path information (S135). The internal state is determined as being in the “acceptable reply” if the acknowledgement notification is received as a reply to the control packet group output in S111. The control unit 36 then transmits the acknowledgement notification stored in the buffer unit 35 to the transmission source edge node (S137). Processing then ends.

If the control unit 36 determines that the internal state is not in the “acceptable reply” (no loop from S133), i.e., that the internal state is in the “unacceptable reply,” processing proceeds to S139. The internal state is determined as being in the “unacceptable reply” if the collision occurrence notification is received as a reply to the control packet group output in S111. The control unit 36 then transmits the collision occurrence notification stored on the buffer unit 35 to the transmission source edge node (S139). Processing thus ends.

The above-described process allows the system to check in advance whether a collision is to occur in another relay node in the communication path.

### Third Embodiment

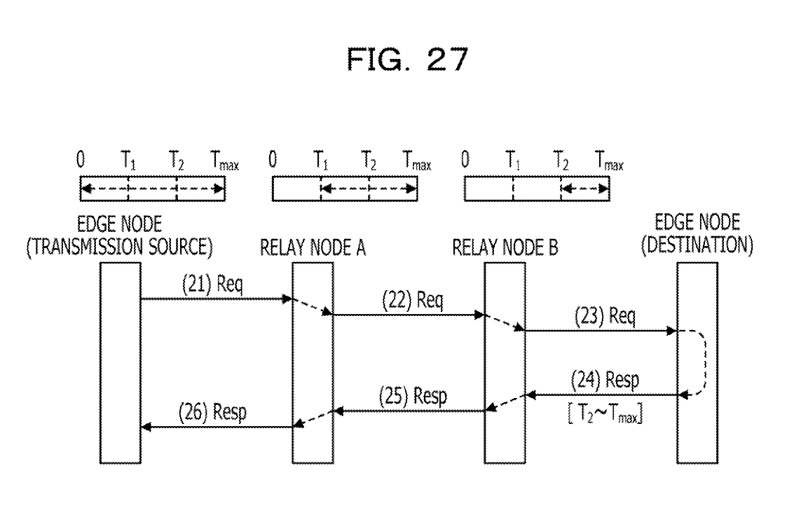

The third embodiment is described below with reference to FIGS. 27-37. In the embodiment, a transmission source edge node outputs a control packet including data representing a use enable period for the transmission of a data packet, and a relay node in a communication path outputs the control packet to a next relay node with an overlapping period left. The overlapping period is a period of the use enable period overlapping an idling period of the own relay node. A remaining period is then returned to the transmission source edge node, and the transmission source edge node determines a transmission timing from the remaining period. The edge nodes and the relay nodes receive data representing a frame length from the management server 5, and operates in accordance with the frame length. Frame start timings of the nodes are not synchronized.

FIG. 27 illustrates a sequence of the embodiment. The transmission source edge node transmits the control packet group to the destination edge node (operation (21) of FIG. 27). The control packet group includes a control packet that includes data representing a use enable period for the transmission of the data packet group and communication path information. The control packet has a period from 0 to Tₘₐₓ set as the use enable period. Label “Req” of FIG. 27 represents a leading packet of the control packet group.

Upon receiving the control packet group, the relay node A identifies an overlapping period of the use enable period set in the control packet and an idling period of the output IF identified by the communication path information. A period from T1 to Tₘₐₓ is set as the overlapping period. The relay node A sets the overlapping period in the control packet, and outputs the control packet group to the relay node B (operation (22)).

Upon receiving the control packet group, the relay node B identifies an overlapping period of the use enable period set in the control packet and an idling period of the output IF identified by the communication path information. A period from T2 to Tₘₐₓ is identified as the overlapping period. The relay node B sets the overlapping period in the control packet, and outputs the control packet group to the destination edge node (operation (23)).

Upon receiving the control packet group from the relay node B, the destination edge node transmits a reply packet with the remaining period (T2 to Tₘₐₓ) set therewithin to the transmission source edge node (operation (24)). Label “Resp” of FIG. 27 represents the reply packet. Upon receiving the reply packet from the destination edge node, the relay node B transmits reply packet to the relay node A (operation (25)). Upon receiving the reply packet from the relay node B, the relay node A transmits the reply packet to the transmission source edge node (operation (26)).

Upon receiving the reply packet, the transmission source edge node determines the transmission timing from the period set in the reply packet and transmits the data packet group at the transmission timing. This process is described in detail below. The frame start timings of the nodes are not synchronized with each other, and the overlapping period is identified taking into consideration a time difference between the nodes.

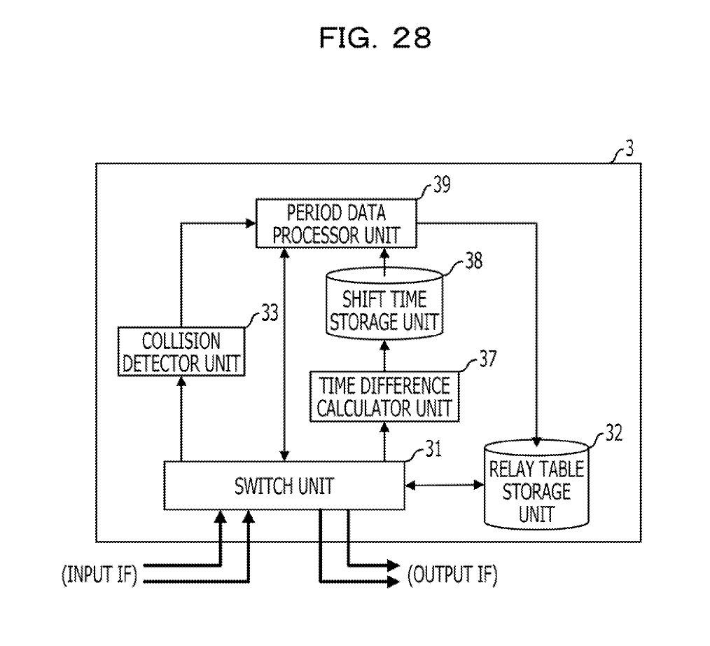

FIG. 28 is a function block diagram of the relay router 3 of the embodiment. The embodiment is based on the premise that the relay router 3 is used in the network system 100 of FIG. 1. The function block diagrams of the edge router 1 and the management server 5 remain identical to those of the first embodiment.

The relay router 3 of the embodiment includes switch unit 31, relay table storage unit 32, collision detector unit 33, time difference calculator unit 37, shift time storage unit 38, and period data processor unit 39. The switch unit 31 and the collision detector unit 33 basically remain unchanged from the counterparts thereof in the first embodiment. In the embodiment, the switch unit 31 outputs the received control packet group to the period data processor unit 39, and outputs the reception start notification of the leading packet of the control packet group to the time difference calculator unit 37. If a collision is detected, the collision detector unit 33 notifies the period data processor unit 39 of the occurrence of the collision. Upon receiving the reception start notification from the switch unit 31, the time difference calculator unit 37 calculates a period from the frame start time of the own node to the reception start of the leading packet of the control packet group (hereinafter referred to as a shift time), and stores the shift time on the shift time storage unit 38. In response to the reception of the control packet group from the switch unit 31, the period data processor unit 39 identifies an overlapping time of the use enable period set in the control packet and the idling time in accordance with data stored on the relay table storage unit 32 and the shift time storage unit 38. The period data processor unit 39 sets the overlapping period in the control packet, and outputs the control packet group to the output IF via the switch unit 31.

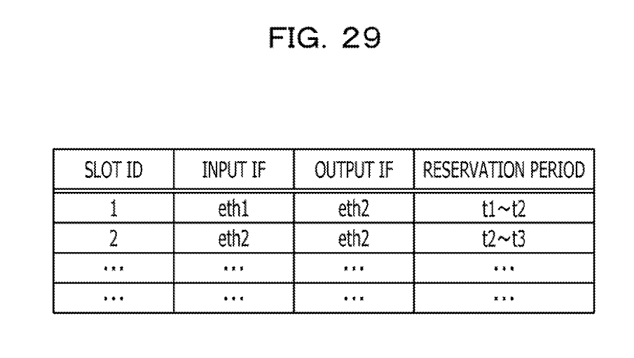

The relay table storage unit 32 of the embodiment stores the relay table of FIG. 29. The relay table of FIG. 29 includes a slot ID column, an input IF column, an output IF column, and a reservation period column. A period from time t1 to time t2 is reserved for the packet transmission of slot ID “1.” A data packet input from an IF of eth1 is output to an IF of eth2. The reservation period is represented by time with reference to the frame start time of the relay node.

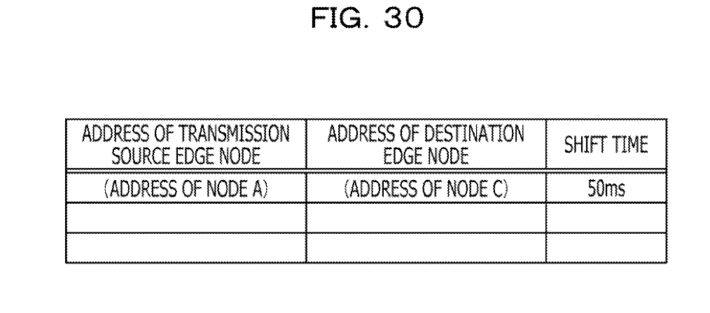

The shift time storage unit 38 stores data of FIG. 30. As illustrated in FIG. 30, the shift time storage unit 38 stores an address of the transmission source edge node, an address of the destination edge node, and the shift time.

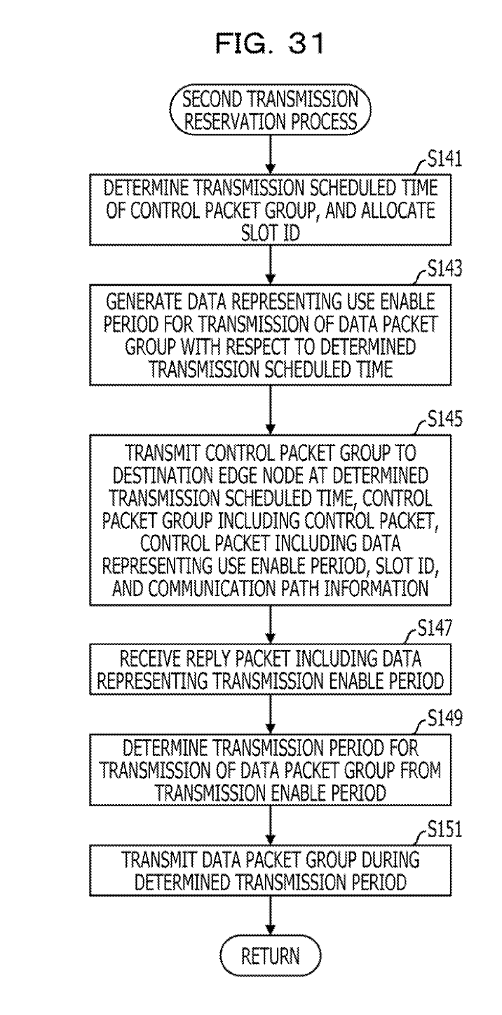

A process of the edge router 1 performed in response to the reception of the packet from the external network is described below. The process flow of the main routine remains unchanged from the process of FIG. 13. In S15, however, a process of FIG. 31 (hereinafter referred to as a second transmission reservation process) is performed in place of the transmission reservation process of FIG. 14. The second transmission reservation process is described below.

The scheduler unit 15 determines a transmission scheduled time of the control packet group, and then allocates a new slot ID (S141 of FIG. 31). The scheduler unit 15 sets the allocated slot ID in the reservation target record on the schedule DB 16. Using data stored on the schedule DB 16, the scheduler unit 15 generates data representing a use enable period for the transmission of the data packet group with respect to the determined transmission scheduled time (hereinafter referred to as use enable period data) (S143).

The scheduler unit 15 transmits the control packet group to the destination edge node at the determined transmission scheduled time, with the control packet group including the control packet, and the control packet including the use enable period data, the slot ID, and the communication path information (S145).

The reply signal receiver unit 18 receives a reply packet including data representing a transmission enable period within which the relay node in the communication path can transmit the data packet group in a collision-free fashion (S147), and outputs the reply packet to the transmission timing calculator unit 17.

Upon receiving the reply packet from the reply signal receiver unit 18, the transmission timing calculator unit 17 determines a transmission period for transmitting the data packet group (i.e., the transmission timing and the transmission time) from the transmission enable period included in the reply packet (S149). The transmission timing calculator unit 17 sets the transmission timing and the transmission time in the reservation target record on the schedule DB 16, and sets “reservation completed” in the accumulated adjustment time column.

The scheduler unit 15 transmits the data packet group to the destination edge node in the transmission period one frame later (S151). The slot ID included in the reservation target record on the schedule DB 16 is set in the leading packet of the data packet group. Processing then returns to the main routine.

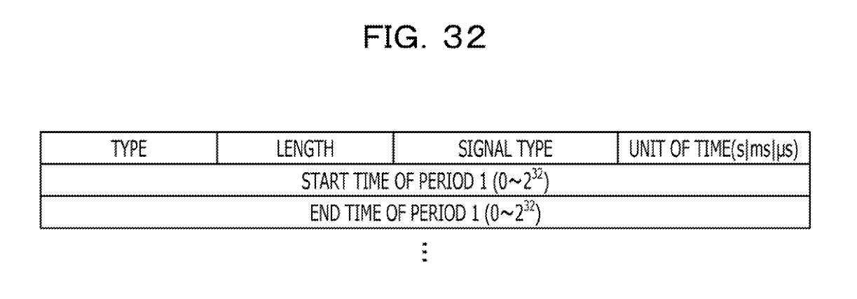

The use enable period data and the transmission enable period data may be set in the option fields of the IP header. Data of FIG. 32 may be set in the option fields. As illustrated in FIG. 32, the option fields includes “type,” “length,” “signal type,” “unit of time,” “start time of period 1,” and “end time of period 1” fields. A new code indicating that the content of the option field is the use enable period data or the transmission enable period data is prepared, and then set in the “type” field. The “length” represents a data length (unit: byte) of the option fields. In the “signal type” field, 0 (=control packet) or 1 (=reply packet) is set. The “unit of time” field represents the unit of time of the adjustment time (0: s, 1: ms, 2: μs). If the use enable period (or the transmission enable period) is a single continuous period, only the “start time of period 1” and the “end time of period 1” are set. If a plurality of periods are used, the “start time” and the “end time” are set for each period.

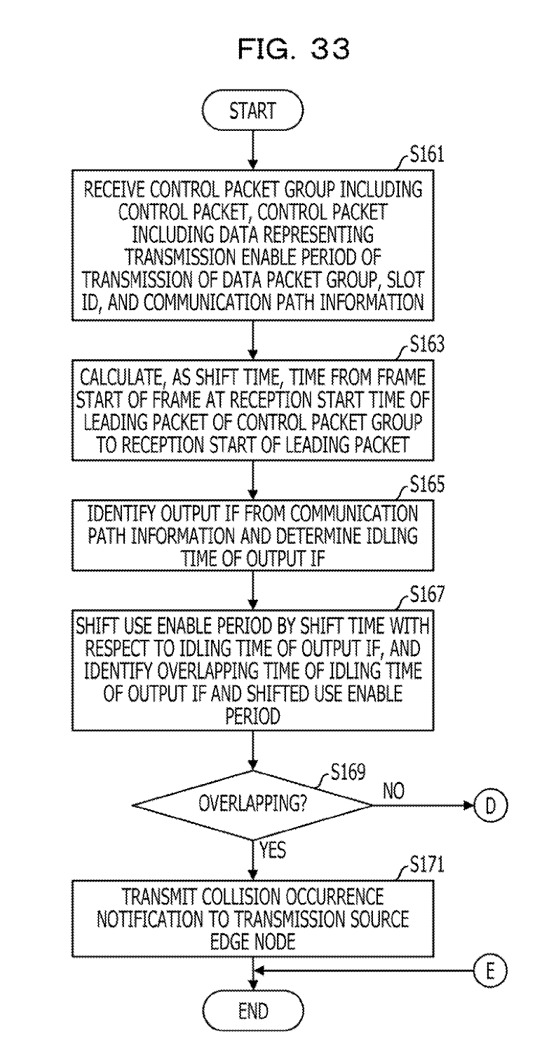

A process of the relay router 3 relaying the control packet group is described below with reference to FIGS. 33-35. The switch unit 31 receives the control packet group including the control packet (S161). The control packet includes data representing the use enable period for the transmission of the data packet group, the slot ID, and the communication path information. The switch unit 31 outputs the control packet and the reception start time of the leading packet of the control packet group to the time difference calculator unit 37, while outputting the control packet to the period data processor unit 39.

In response to the reception of the reception start time and the control packet from the switch unit 31, the time difference calculator unit 37 calculates the shift time from the frame start of the own relay node to the reception start of the leading packet of the control packet group, and stores the shift time on the shift time storage unit 38 (S163). It is noted that the time difference calculator unit 37 stores on the shift time storage unit 38 the shift time with an address of the transmission source edge node and an address of the destination edge node set in the IP header of the control packet mapped to the shift time.

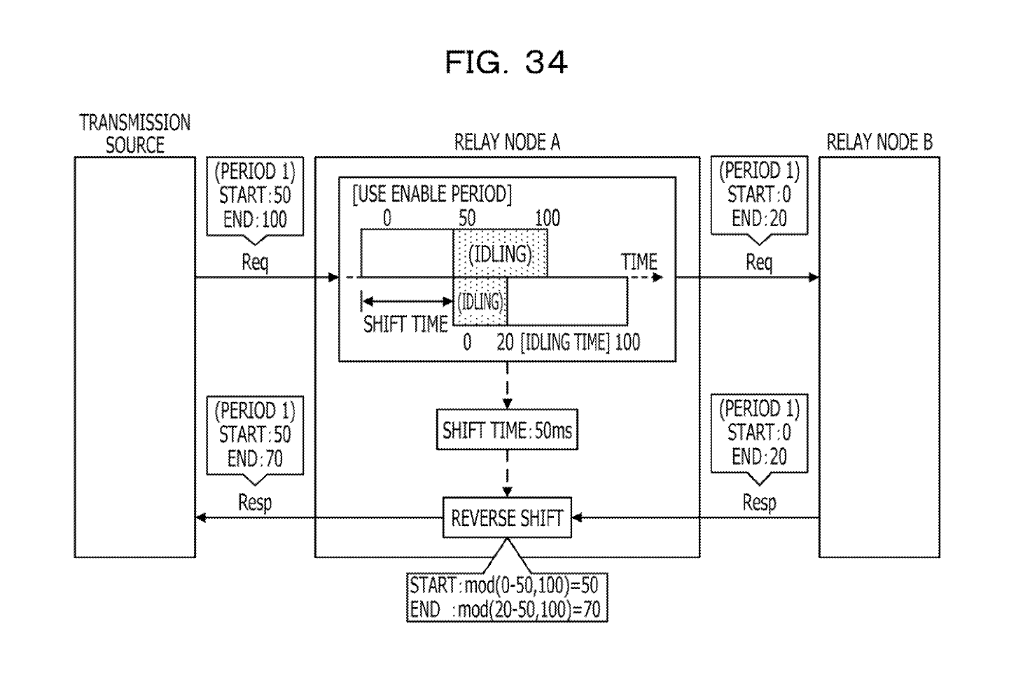

Upon receiving the control packet from the switch unit 31, the period data processor unit 39 identifies the output IF from the communication path information included in the control packet and identifies the idling time of the identified output IF from the data stored on the relay table storage unit 32 (S165). More specifically, the period data processor unit 39 retrieves from the relay table storage unit 32 a record including the identification information of the identified output IF, and identifies, as the idling time, time other than the reservation period set in the retrieved record. The period data processor unit 39 shifts the use enable period by the shift time with respect to the idling period of the output IF, and then identifies an overlapping period of the idling time of the output IF and the shifted use enable time (S167). The process content in step S167 is diagrammatically illustrated in FIG. 34.

As illustrated in FIG. 34, one frame is 100 ms, and period 1 (start time: 50 ms, and end time: 100 ms) is set in the control packet as the use enable period. Label “Req” of FIG. 34 represents the control packet. The reception start time of the leading packet of the control packet group is at 50 ms, and a period from time 0 to time 20 is identified as the idling time of the output IF. The shift time is 50 ms. If the use enable period is shifted by the shift time with respect to the idling time of the output IF, the period from time 0 to time 20 is identified as the overlapping time as illustrated in FIG. 34.

If the idling time of the output IF does not overlap the use enable period (no loop from S169), the period data processor unit 39 transmits the collision occurrence notification to the transmission source edge node (S171). In the embodiment, the transmission of the collision occurrence notification notifies the transmission source edge node that no transmission enable period is available. Processing thus ends.

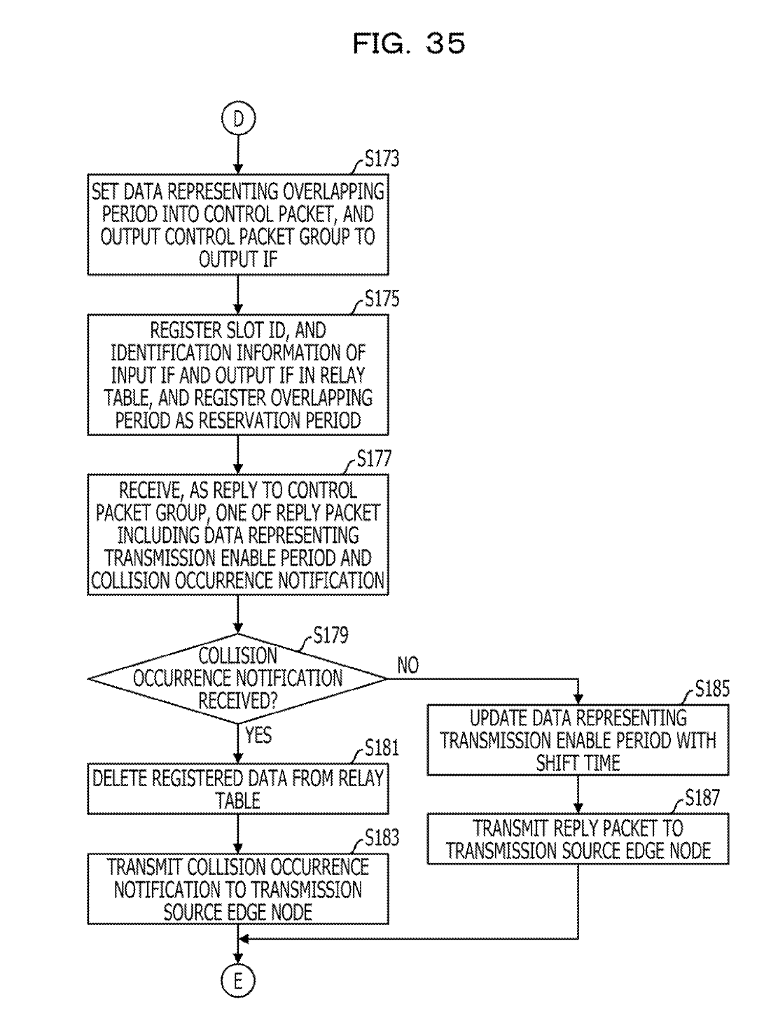

If the idling time of the output IF overlaps the use enable period (yes loop from S169), processing proceeds to a process of FIG. 35 via a point D.

Referring to FIG. 35, processing proceeds to the process of FIG. 35 via the point D. The period data processor unit 39 sets data representing the overlapping period in the control packet, and outputs the control packet group to the output IF via the switch unit 31 (S173). As illustrated in FIG. 34, the start time: 0, and the end time: 20 are set in the control packet.

The period data processor unit 39 registers the slot ID, the identification information of the input IF, and the identification information of the output IF on the relay table storage unit 32, and registers as the reservation period the overlapping period on the relay table storage unit 32 (S175). At this point of time, the overlapping period is registered as the reservation time because it is unknown which part of the overlapping period is actually used to transmit the data packet group.

The switch unit 31 then receives one of the reply packet including data representing the transmission enable period and the collision occurrence notification (S177), and outputs the received data to the period data processor unit 39. If the control packet group reaches the destination edge node, the switch unit 31 receives the reply packet from the destination edge node. If it is determined that no overlapping period is present in the relay node in the communication path, the switch unit 31 receives the collision occurrence notification from the relay node.

Upon receiving the collision occurrence notification from the switch unit 31 (yes loop from S179), the period data processor unit 39 deletes the data registered in the relay table in S175 (S181). The period data processor unit 39 then transmits the collision occurrence notification to the transmission source edge node (S183). Processing returns to the process of FIG. 33 via a point E, and ends.

Upon receiving the reply packet from the switch unit 31 (no loop from S179), the period data processor unit 39 searches the shift time storage unit 38 for the transmission IP address and the reception IP address included in the IP header of the reply packet, and updates the transmission enable period in accordance with the shift time corresponding to the transmission source edge node and the destination edge node (S185). Operation S185 is specifically described with reference to FIG. 34.

With reference to FIG. 34, the relay node A identifies as the overlapping period the period from 0 ms to 20 ms. The relay node A sets the overlapping period (start time: 0 ms and end time: 20 ms) in the control packet and then outputs the control packet to the next node. The relay node A may then receive the reply packet including the data representing a transmission enable time (start time: 0 and end time 20). As illustrated in FIG. 34, the period from time 0 to time 20 in the relay node A corresponds to time 50 to time 70 in the transmission source. The relay node A thus expresses the transmission enable period in time of the transmission source, and then transmits the reply packet to the transmission source. As illustrated in FIG. 34, the shift time is calculated as 50 ms, the start time of the transmission enable period is 0−50=−50 ms, and the end time of the transmission enable period is 20−50=−30 ms. If one frame is 100 ms, the start time is mod(−50,100)=50 ms, and the end time is mod(−30,100)=70.

The period data processor unit 39 sets the data representing the updated transmission enable period in the reply packet, and transmits the reply packet to the transmission source edge node (S187). As illustrated in FIG. 34, the relay node A outputs to the transmission source the reply packet including the data representing the transmission enable period (the start time: 50 and the end time: 70). Processing returns to the process of FIG. 33 via the point E, and then ends.

The above-described process appropriately identifies the overlapping period of the use enable period and the idling time of the relay node.

The use enable period is shifted by the shift time with respect to the idling period of the relay node in S167. Alternatively, the idling period of the relay node may be shifted by the shift time with respect to the use enable period. In this case, however, a period resulting from shifting the identified overlapping period by the shift time in a direction opposite to the direction of the idling period may be registered as the reservation period in S175. As illustrated in FIG. 34, the idling period of the relay node A is shifted with respect to the use enable period by the shift time (=50 ms), and the overlapping period is then identified. A period from time 50 to time 70 is identified as the overlapping period. If the overlapping period is reverse shifted by the shift time, the start time is 50−50=0, and the end time is 70−50=20. The period from time 0 to time 20 is thus registered as the reservation period on the relay table storage unit 32. If the overlapping period is identified with the idling period of the relay node A shifted with respect to the use enable period, time on the transmission source edge node serves as a base, and operation in S185 is skipped.

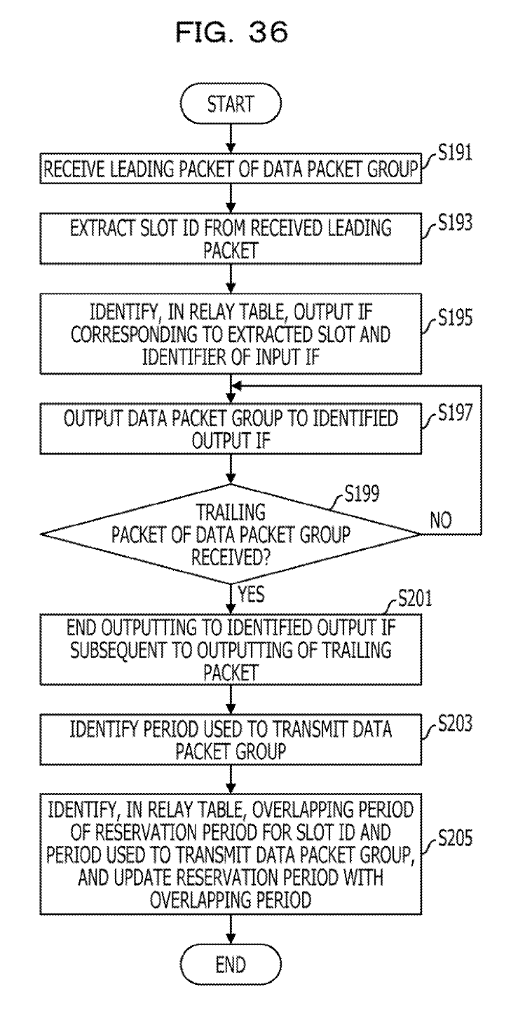

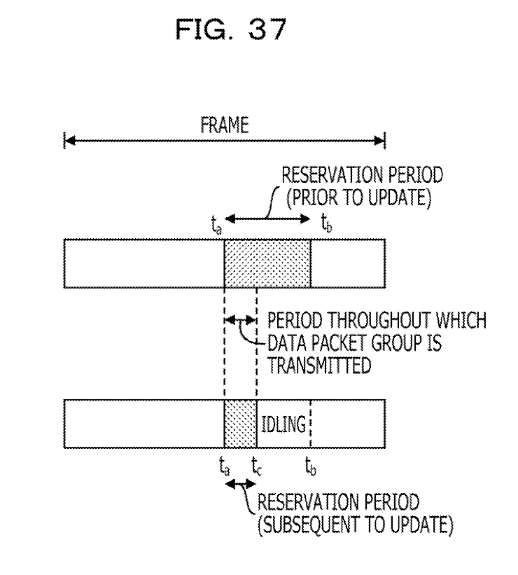

With reference to FIGS. 36 and 37, a process of the relay router 3 performed in response to the reception of the data packet group is described below. The switch unit 31 in a given IF receives the leading packet of a data packet group (S191 of FIG. 36). The switch unit 31 stores in the storage unit the reception start time of the leading packet of the data packet group. The switch unit 31 extracts the slot ID from the received leading packet (S193). The switch unit 31 identifies the output IF corresponding to the extracted ID and the identification information of the input IF in the relay table stored in the relay table storage unit 32 (S195). The switch unit 31 outputs the data packet group to the identified output IF (S197). The switch unit 31 then determines whether the trailing packet of the data packet group has been received (S199). If the trailing packet of the data packet group has not been received (no loop from S199), processing returns to S197 to continue to output the data packet group to the identified output IF.

If the trailing packet of the data packet group has been received (yes loop from S199), the switch unit 31 ends the outputting to the output IF after outputting the trailing packet to the identified output IF (S201). The switch unit 31 stores the reception end time of the trailing packet of the data packet group on the storage unit.

The switch unit 31 identifies a period used to transmit the data packet group in accordance with the reception start time of the leading packet of the data packet group to the trailing packet of the data packet group stored on the storage unit (S203). The switch unit 31 identifies on the relay table storage unit 32 the record including the slot ID extracted in S193. The switch unit 31 identifies the overlapping period between the reservation time of the identified record and the period used to transmit the data packet group, and updates the reservation time with the identified overlapping period (S205). The operation in S205 is diagrammatically illustrated in FIG. 37.

Through the above operation in S167, a period from time tₐ to time t_{b} may be identified as the overlapping period, and may be registered as the reservation time. Since the relay node does not know which part of the overlapping period is used until the data packet group has been received, the overlapping period is registered as the reservation time. The period actually used to transmit the data packet group is assumed here to be a period from time tₐ to time t_{c}. In S205, a period from tₐ to time t_{c} is identified as the overlapping period, and the reservation time is the period from tₐ to time t_{c}. A period from time t_{c} to time t_{b} is regarded as an idling period, and is thus used to transmit another data packet group.

The embodiments of the technique have been described. The technique is not limited to the embodiments. For example, the function block diagrams of the edge router 1, the relay router 3, and the management server 5 do not necessarily correspond an actual program module configuration. The structure of each of the storage units has also been described for exemplary purposes only. In the process flow, operations may be changed in order as long as the process results remain the same. Operations may be performed in parallel.

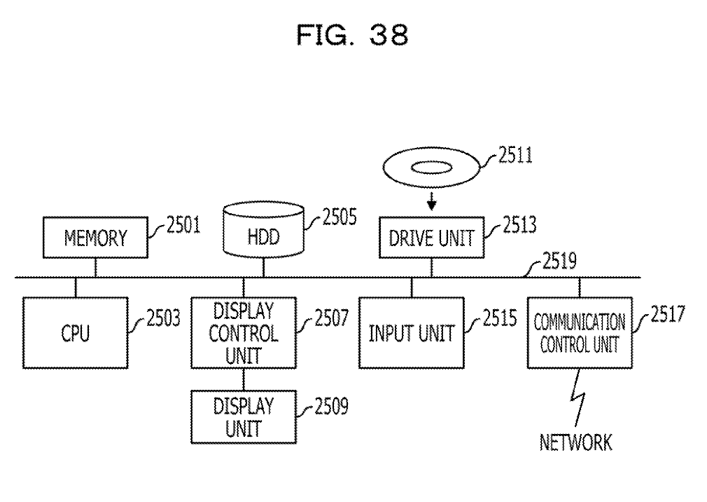

The management server 5 described above may be a computer. As illustrated in FIG. 38, the computer includes memory 2501, CPU 2503, hard disk drive (HDD) 2505, display control unit 2507 connected to a display unit 2509, drive unit 2513 for a removable disk 2511, input unit 2515, communication control unit 2517 connected to a network, and bus 2519 interconnecting these elements. An operating system (OS) and an application program for executing the processes of the embodiments are stored on the HDD 2505. When the CPU 2503 executes the program, the program is read from the HDD 2505 onto the memory 2501. The CPU 2503 controls the display control unit 2507, the communication control unit 2517, and the drive unit 2513 as appropriate to cause these elements to perform the processes thereof in accordance with the process of the program. Interim process data is mainly stored on the memory 2501, and if necessary, may also be stored on the HDD 2505. According to the embodiments of the technique, the application program for executing the above-described processes may be distributed in a stored state on the removable disk 2511, and then installed from the drive unit 2513 to the HDD 2505. The program may also be installed onto the HDD 2505 via a network such as the Internet and the communication control unit 2517. The computer executes the above-described functions with hardware, such as the CPU 2503 and the memory 2501, and with the OS and the application program operating in cooperation with each other.

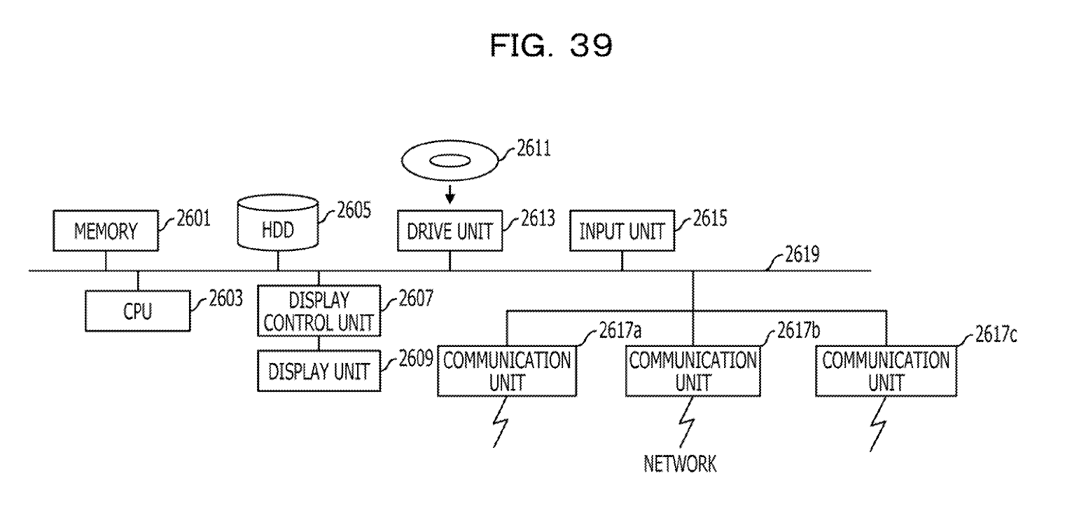

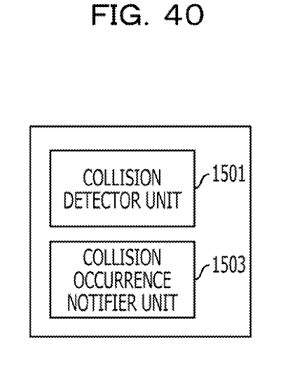

As illustrated in FIG. 39, each of the edge router 1 and the relay router 3 may include memory 2601, CPU 2603, hard disk drive (HDD) 2605, display control unit 2607 connected to a display unit 2609, drive unit 2613 for a removable disk 2611, input unit 2615, communication control units 2617 (2617a-2617c in FIG. 39) connected to networks, and bus 2619 interconnecting these elements. Depending on applications, the display control unit 2607, the display unit 2609, the drive unit 2613, and the input unit 2615 may not be included in the router. An operating system (OS) and an application program for executing the processes of the embodiments are stored on the HDD 2605. When the CPU 2603 executes the program, the program is read from the HDD 2605 onto the memory 2601. The CPU 2603 controls the display control unit 2607, the communication control units 2617, and the drive unit 2613 as appropriate to cause these elements to perform the processes thereof in accordance with the process of the program. Data input through one communication unit 2617 is output through another communication unit 2617. The CPU 2607 controls the communication units 2617 to switch destinations. Interim process data is stored mainly on the memory 2601, and if necessary, may also be stored on the HDD 2605. According to the embodiments of the technique, the application program for executing the above-described processes may be distributed in a stored state on the removable disk 2611, and then installed from the drive unit 2613 to the HDD 2605. The program may also be installed onto the HDD 2605 via a network such as the Internet and the communication control unit 2617. The computer executes the above-described functions with hardware, such as the CPU 2603 and the memory 2601, and with the OS and the application program operating in cooperation with each other.

The embodiments may be summarized as below.

The relay apparatus of the first embodiment includes (A) a collision detector unit (the collision detector unit 1501 of FIG. 40) for detecting a collision, at which a second transmission source interface receives a second control packet group from a second communication apparatus while a first transmission source interface receives one of a first data packet group and a first control packet group from a first communication apparatus, the second control packet group being used to reserve a transmission of a second data packet group during a constant period later than a present frame by one frame out of a frame string representing an operation period of the second communication apparatus, and a transmission destination interface of the second control packet group matching a transmission destination interface of one of the first data packet group and the first control packet group, and (B) a collision occurrence notifier unit (the collision occurrence notifier unit 1503 of FIG. 40) for transmitting a collision occurrence notification to the second communication apparatus in response to a detection of the collision, the collision occurrence notification including adjustment time longer than time from a reception start of a leading packet of the second control packet group to a reception end of a trailing packet of one of the first data packet group and the first control packet group.

If the collision occurs in the relay apparatus, relaying the data packet group in a bufferless fashion at the transmission timing intended by the second communication is difficult. The second communication apparatus is thus notified of the above-described adjustment time to shift the transmission timing of the second control packet group. If the second control packet group does not collide at any of the relay apparatuses in the communication path, data communication is performed without the need for establishing synchronization between the communication apparatuses.

The second control packet group may include a control packet including an identifier and communication path information. The control packet is to be set in the leading packet of the second data packet group. The relay apparatus may further include a switch unit. If no collision is detected during the reception of the second control packet group, the switch unit outputs the second control packet group to a transmission destination interface identified by the communication path information included in the control packet in the second control packet group, and registers, in a relay table, reservation information, the reservation information including the identifier included in the control packet, and identification information of the second transmission source interface and the transmission destination interface. With the reservation information registered in this way, the second data packet group to be transmitted later may be relayed appropriately.

If the collision occurrence notification is received from another relay apparatus in a communication path identified by the communication path information as a reply to the second control packet group, the switch unit may delete the registered reservation information from the relay table and transmit the collision occurrence notification to the second communication apparatus. Upon receiving an acknowledgement notification from a transmission destination communication apparatus identified by the communication path information as a reply to the second control packet group, the switch unit may use the registered reservation information to relay the second data packet group and transmit the acknowledgement notification to the second communication apparatus. Even if no collision is detected in own relay apparatus, a collision may still be detected in another relay apparatus. In such a case, the reservation information registered on own relay apparatus is deleted. If no collision is detected in another relay apparatus, the data packet group is relayed using the registered reservation information.

The leading packet of the second data packet group may include the same identifier as the identifier included in the control packet used to reserve the transmission of the second data packet group. If the second transmission source interface receives the leading packet of the second data packet group, the switch unit identifies the transmission destination interface corresponding to the identification information of the second transmission source interface and the identifier included in the leading packet of the second data packet group, and outputs the second data packet group to the identified transmission destination interface until the reception end of a trailing packet of the second data packet group. With this arrangement, the data packet group is relayed without the need for a routing process. Since the data packet groups are free from collision with each other, no buffer is needed. Power saving may be achieved in the relay apparatus.

The relay apparatus may further include a control unit. The control unit outputs, in response to the detection of a collision, the second control packet group to a transmission destination interface identified by the communication path information included in the control packet of the second control packet group after the reception end of the trailing packet of one of the first data packet group and the first control packet group. With this arrangement, whether a collision is to occur in another relay apparatus is checked in advance.

Upon receiving an acknowledgement notification from a transmission destination communication apparatus identified by the communication path information and the second control packet group retransmitted from the second communication apparatus in response to the collision occurrence notification transmitted by the collision occurrence notifier unit, the control unit registers, in a relay table, reservation information, the reservation information including the identifier, included in the control packet, and identification information of the second transmission source interface and the transmission destination interface, and transmits the acknowledgement notification to the second communication apparatus. Upon receiving a collision occurrence notification from another relay apparatus in a communication path identified by the communication path information and the second control packet group retransmitted by the second communication apparatus, the control unit transmits the collision occurrence notification to the second communication apparatus. Whether a collision is to occur in another relay apparatus is checked in advance. To this end, the reservation time may be registered in response to the acknowledgement notification from the transmission destination communication apparatus and the second control packet group retransmitted from the second communication apparatus if the second control packet group is output to the transmission destination interface.

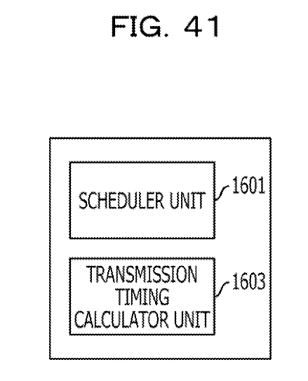

The communication apparatus of the second embodiment includes (A) a scheduler unit (the scheduler unit 1601 of FIG. 41) and (B) a transmission timing calculator unit (the transmission timing calculator unit 1603 of FIG. 41). The scheduler unit transmits a first control packet group to a transmission destination communication apparatus of a first data packet group at a first transmission timing within a first frame of a frame string representing an operation period, the first control packet group reserving a transmission of the first data packet group during a constant period of a second frame subsequent to the first frame of the frame string. If a collision occurs at which a relay apparatus in a communication path routing to a transmission destination communication apparatus of the first data packet group receives the first control packet group while receiving one of a second data packet group and a second control packet group having the same transmission destination interface, a collision occurrence notification is transmitted from the relay apparatus. The collision occurrence notification includes adjustment time longer than time from a reception start of a leading packet of the first control packet group to a reception end of a trailing packet of one of the second data packet group and the second control packet group. Upon receiving the collision occurrence notification, the transmission timing calculator unit calculates a second transmission timing into which the first transmission timing is shifted later by the adjustment time, and causes the scheduler unit to retransmit the first control packet group at the second transmission timing within the second frame.

This arrangement allows the first control packet group to be retransmitted with the currently occurring collision bypassed. If yet another collision occurs, the first control packet group may be retransmitted with that collision bypassed. The transmission of the data packet group in a constant period one frame later is reserved. Time division communications are thus performed even if no synchronization is established among the communication apparatuses.

The first control packet group may include a control packet including an identifier identifying the constant period within the frame. Upon receiving an acknowledgement notification from the transmission destination communication apparatus of the first data packet group as a reply to the first control packet group, the scheduler unit sets at a leading packet of the first data packet group the same identifier as the identifier included in the control packet within the first control packet group transmitted last and transmits the first data packet group at a transmission timing later than by one frame a transmission timing of the first control packet group transmitted last. The data packet group is thus transmitted to the transmission destination communication apparatus at a timing free from a collision with another data packet group.

The communication apparatus of the third embodiment includes (A) a scheduler unit and (B) a transmission period determiner unit. The scheduler unit generates data representing a use enable period for a transmission of a data packet group with a transmission scheduled time of a control packet group serving as reference time, and transmits the control packet group including a control packet to a transmission destination communication apparatus of the data packet group at the transmission scheduled time, the control packet including the data representing the use enable period and an identifier allocated to the transmission of the data packet group. Upon receiving a reply packet including data representing as a transmission enable time an overlapping period of an idling period of a relay apparatus in a communication path routing to the transmission destination communication apparatus of the data packet group and the use enable period, the transmission determiner unit determines a transmission period for the data packet group in accordance with the transmission enable period. The scheduler unit sets at a leading packet of the data packet group the identifier allocated to the transmission of the data packet group and transmits the data packet group during the determined transmission period. With this arrangement, the transmission period of the data packet group is determined from the transmission enable period. The data packet group may thus be transmitted in a manner free from collision with another data packet group. Time-division communication is thus performed even if no synchronization is established among the communication apparatuses.

The relay apparatus of the fourth embodiment includes (A) a time difference calculator unit and (B) a period data processor unit. Upon receiving from a communication apparatus a control packet group including a control packet, the control packet including data representing a use enable period for transmission of a data packet group, an identifier allocated to the transmission of the data packet group, and communication path information, the time difference calculator unit calculates a shift time from a frame start time of a frame at a reception start time of a leading packet of the control packet group within a frame string representing an operation period of own relay apparatus to a reception start of the leading packet of the control packet group. The period data processor unit shifts, by the shift time, one of an idling period of a transmission destination interface identified by the communication path information included in the control packet and the use enable period with respect to the other of the idling period and the use enable period, identifies a first overlapping period between the idling period of the transmission destination interface and the use enable period, sets data representing the first overlapping period at the control packet, and outputs the control packet to the transmission destination interface. One of the use enable period of the control packet and the idling period of the transmission source interface is shifted with respect to the other of the use enable period and the idling period. The overlapping period is thus appropriately identified.

The control packet may further include an identifier allocated to the transmission of the data packet group. If the first overlapping period is a period identified with respect to the use enable period, the period data processor unit registers, in a relay table, reservation information, the reservation information including data representing a reservation period into which the first overlapping period is shifted by the shift time in a direction opposite to the direction of the idling time of the transmission destination interface, the identifier included in the control packet, and identification information of a transmission source interface and the transmission destination interface. If the first overlapping period is a period identified with respect to the idling time of the transmission source interface, the period data processor unit registers, in the relay table, reservation information, the reservation information including, as data representing the reservation period, data representing the first overlapping period, the identifier included in the control packet, and the identification information of the transmission source interface and the transmission destination interface. Which part of the overlapping period to use to transmit the data packet group is not known at the moment the control packet is received. The reservation information including as the reservation period the overlapping period is thus registered.

A leading packet of the data packet group may include the identifier allocated to the transmission of the data packet group. The relay apparatus of the fourth embodiment may further include a switch unit. In response to the reception of the leading packet of the data packet group, the switch unit identifies the transmission destination interface corresponding to the identification information of the transmission source interface and the identifier included in the leading packet of the data packet group in the relay table, outputs the data packet group to the identified transmission destination interface until a reception end of a trailing packet of the data packet group, identifies a second overlapping period of a reservation period corresponding to the identification information of the transmission source interface and the identifier included in the leading packet of the data packet group in the relay table, and a period from a reception start of the leading packet of the data packet group to a reception end of the trailing packet of the data packet group, and updates the reservation period in the relay table with the identified second overlapping period. With this arrangement, a portion of the reservation period unused for the transmission of the data packet group may be excluded from the reservation period, and may be allocated to transmit another data packet group.

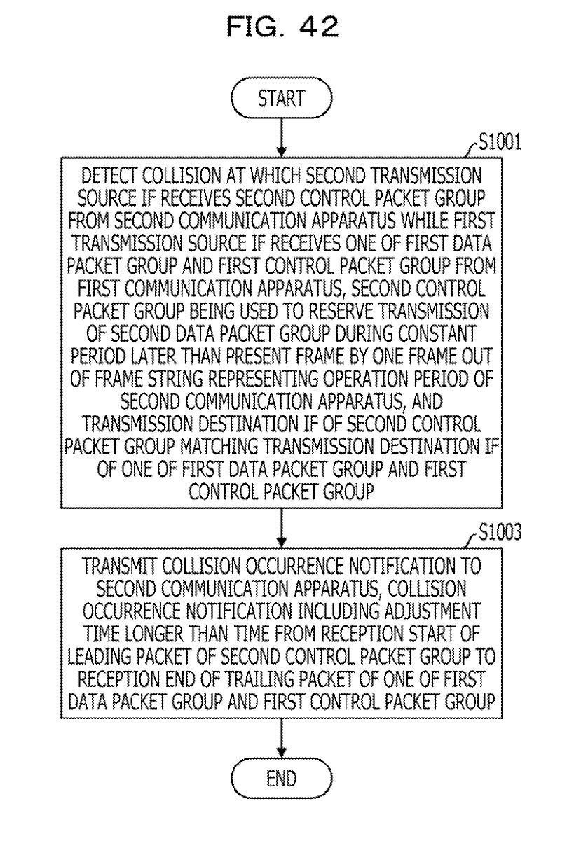

A communication control method of a fifth embodiment of the technique includes (A) a step (S1001 of FIG. 42) of detecting a collision, at which a second transmission source interface receives a second control packet group from a second communication apparatus while a first transmission source interface receives one of a first data packet group and a first control packet group from a first communication apparatus, the second control packet group being used to reserve a transmission of a second data packet group during a constant period later than a present frame by one frame out of a frame string representing an operation period of the second communication apparatus, and a transmission destination interface of the second control packet group matching a transmission destination interface of one of the first data packet group and the first control packet group, and (B) a step (S1003 of FIG. 42) of transmitting a collision occurrence notification to the second communication apparatus in response to a detection of the collision, the collision occurrence notification including adjustment time longer than time from a reception start of a leading packet of the second control packet group to a reception end of a trailing packet of one of the first data packet group and the first control packet group.

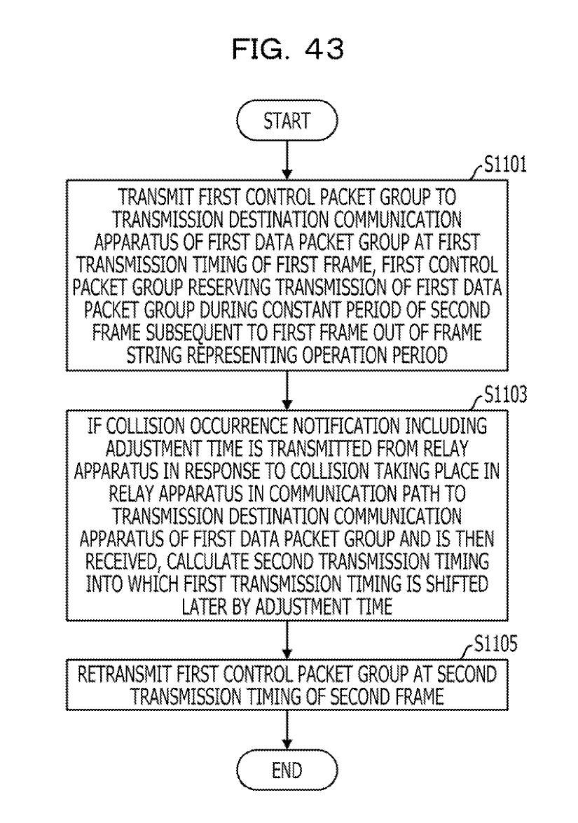

A communication control method of a sixth embodiment of the technique includes (A) a step (S1101 of FIG. 43) of transmitting a first control packet group to a transmission destination communication apparatus of a first data packet group at a first transmission timing within a first frame of a frame string representing an operation period, the first control packet group reserving a transmission of the first data packet group during a constant period of a second frame subsequent to the first frame of the frame string, (B) a step (S1103 of FIG. 43) of calculating a second transmission timing, into which the first transmission timing is shifted later by the adjustment time, if a collision occurs at which a relay apparatus in a communication path routing to a transmission destination communication apparatus of the first data packet group receives the first control packet group while receiving one of a second data packet group and a second control packet group having the same transmission destination interface as the transmission destination of the first control packet, and if a collision occurrence notification is transmitted from the relay apparatus, and then received, the collision occurrence notification including adjustment time longer than time from a reception start of a leading packet of the first control packet group to a reception end of a trailing packet of one of the second data packet group and the second control packet group, and (C) a step (S1105 of FIG. 43) of retransmitting the first control packet group at the second transmission timing within the second frame.

A communication control method of a seventh embodiment of the technique includes (A) a step of generating data representing a use enable period for a transmission of a data packet group with a transmission scheduled time of a control packet group serving as reference time, and transmitting the control packet group including a control packet to a transmission destination communication apparatus of the data packet group at the transmission scheduled time, the control packet including the data representing the use enable period and an identifier allocated to the transmission of the data packet group, (B) a step of determining a transmission period for the data packet group in accordance with a transmission enable period if a reply packet is received, the reply packet including data representing as the transmission enable time an overlapping period of an idling period of a relay apparatus in a communication path routing to the transmission destination communication apparatus of the data packet group and the use enable period, and (C) a step of setting at a leading packet of the data packet group the identifier allocated to the transmission of the data packet group and transmitting the data packet group during the determined transmission period.

A communication control method of an eighth embodiment of the technique includes (A) a step of calculating a shift time from a frame start time of a frame at a reception start time of a leading packet of a control packet group within a frame string representing an operation period of own relay apparatus to a reception start of the leading packet of the control packet group, if the control packet group is received from a communication apparatus, the control packet group including a control packet, the control packet including data representing a use enable period for transmission of a data packet group, an identifier allocated to the transmission of the data packet group, and communication path information, (B) a step of shifting, by the shift time, one of an idling period of a transmission destination interface identified by the communication path information included in the control packet and the use enable period with respect to the other of the idling period and the use enable period, and identifying a first overlapping period between the idling period of the transmission destination interface and the use enable period subsequent to the shifting, and (C) a step of setting data representing the first overlapping period at the control packet, and outputting to the transmission destination interface the control packet with the first overlapping period set.

A program for causing a computer to perform the process of the information integration method is produced. The program may be stored on one of computer-readable storage media including a flexible disk, a CD-ROM, an optical disk, a semiconductor memory, and a hard disk, or may be stored in a storage device. Interim process results may be temporarily stored in a storage device such as a RAM.

In the above embodiments, the edge routers or the relay routers include, for example, a plurality of communication interfaces, a processor, a memory, a logic circuit, and so on. The communication interfaces are a device for communicating to other apparatus. Examples of the network interface include Ethernet interface and a wireless LAN interface. The processor is a device for processing data. Examples of the processor include a central processing unit (CPU) and a digital signal processor (DSP). The memory is a device for storing data. Examples of the memory include a read only memory (ROM) and a random access memory (RAM). The logic circuit is an electronic circuit which performs a logical operation. Examples of the logic circuit include a large scale integration (LSI) circuit, a field-programming gate array (FPGA), Application Specific Integrated Circuit (ASIC). In the above embodiments, the hardware realizes the respective functions of the edge routers or the relay routers. For example, the switch unit of FIG. 7 is realized as a switch module by the logic circuit.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A relay apparatus comprising:
a plurality of communication interfaces; and
a processor configured to
detect a collision, at which a second communication interface receives a second control packet group from a second communication apparatus while a first communication interface receives one of a first data packet group and a first control packet group from a first communication apparatus, the second control packet group being used to reserve a transmission of a second data packet group during a constant period later than a present frame by one frame out of a frame string representing an operation period of the second communication apparatus, and a communication interface of the second control packet group matching a communication interface of one of the first data packet group and the first control packet group; and
transmit a collision occurrence notification to the second communication apparatus in response to a detection of the collision, the collision occurrence notification including an adjustment time longer than a time from a reception start of a leading packet of the second control packet group to a reception end of a trailing packet of one of the first data packet group and the first control packet group.

2. The relay apparatus according to claim 1, further comprising a switching module,
wherein the second control packet group includes a control packet including an identifier and communication path information, the control packet to be set in a leading packet of the second data packet group; and
wherein when no collision is detected during the reception of the second control packet group, the switching module is configured to output the second control packet group to a third communication interface identified by the communication path information included in the control packet in the second control packet group, and register, in a relay table, reservation information, the reservation information including the identifier included in the control packet, and identification information of the second communication interface and the third communication interface.

3. The relay apparatus according to claim 2, wherein when the collision occurrence notification is received from another relay apparatus in a communication path identified by the communication path information as a reply to the second control packet group, the switching module is configured to delete the registered reservation information from the relay table and transmit the collision occurrence notification to the second communication apparatus; and
wherein upon receiving an acknowledgement notification from a transmission destination communication apparatus identified by the communication path information as a reply to the second control packet group, the switching module is configured to use the registered reservation information to relay the second data packet group and transmit the acknowledgement notification to the second communication apparatus.

4. The relay apparatus according to claim 3, wherein the leading packet of the second data packet group includes the same identifier as the identifier included in the control packet used to reserve the transmission of the second data packet group; and
wherein when the second communication interface receives the leading packet of the second data packet group, the switching module is configured to identify a fourth communication interface corresponding to the identification information of the second communication interface and the identifier included in the leading packet of the second data packet group, and output the second data packet group to the fourth communication interface until the reception end of a trailing packet of the second data packet group.

5. The relay apparatus according to claim 1,
wherein the second control packet group includes a control packet including communication path information; and
wherein the processor is configured to output, in response to the detection of the collision, the second control packet group to a third communication interface identified by the communication path information included in the control packet of the second control packet group after the reception end of the trailing packet of one of the first data packet group and the first control packet group.

6. The relay apparatus according to claim 5, wherein the control packet includes an identifier to be set in the leading packet of the second data packet group,
wherein upon receiving an acknowledgement notification from a transmission destination communication apparatus identified by the communication path information and the second control packet group retransmitted from the second communication apparatus in response to the collision occurrence notification transmitted, the processor is configured to register, in a relay table, reservation information, the reservation information including the identifier, included in the control packet, and identification information of the second communication interface and the third communication interface, and transmitting the acknowledgement notification to the second communication apparatus; and
wherein upon receiving a collision occurrence notification from another relay apparatus in a communication path identified by the communication path information and the second control packet group retransmitted by the second communication apparatus, the processor is configured to transmit the collision occurrence notification to the second communication apparatus.

7. A communication apparatus comprising:
a plurality of communication interfaces; and
a processor configured to
transmit a first control packet group to a a destination communication apparatus of a first data packet group at a first transmission timing within a first frame of a frame string representing an operation period, the first control packet group reserving a transmission of the first data packet group during a constant period of a second frame subsequent to the first frame of the frame string;
wherein when a collision occurs in which a relay apparatus in a communication path routing to the transmission destination communication apparatus of the first data packet group receives the first control packet group while receiving one of a second data packet group and a second control packet group having the same communication interface, a collision occurrence notification is transmitted from the relay apparatus, the collision occurrence notification including an adjustment time longer than a time from a reception start of a leading packet of the first control packet group to a reception end of a trailing packet of one of the second data packet group and the second control packet group, and upon receiving the collision occurrence notification, the processor is configured to calculate a second transmission timing into which the first transmission timing is shifted later by the adjustment time, and retransmit the first control packet group at the second transmission timing within the second frame.

8. The communication apparatus according to claim 7, wherein the first control packet group includes a control packet including an identifier identifying the constant period within the frame; and
wherein upon receiving an acknowledgement notification from the transmission destination communication apparatus of the first data packet group as a reply to the first control packet group, the processor is configured to set at a leading packet of the first data packet group the same identifier as the identifier included in the control packet within the first control packet group transmitted last and transmit the first data packet group at a transmission timing later than by one frame a transmission timing of the first control packet group transmitted last.

9. A relay apparatus comprising:
a plurality of communication interfaces; and
a processor;
wherein upon receiving from a communication apparatus a control packet group including a control packet, the control packet including data representing a use enable period for transmission of a data packet group, an identifier allocated to the transmission of the data packet group, and communication path information, the processor is configured to calculate a shift time from a frame start time of a frame at a reception start time of a leading packet of the control packet group within a frame string representing an operation period of the relay apparatus to a reception start of the leading packet of the control packet group; and
wherein the processor is configured to shift, by the shift time, one of an idling period of a first communication interface identified by the communication path information included in the control packet and the use enable period with respect to the other of the idling period and the use enable period, identify a first overlapping period between the idling period of the first communication interface and the use enable period, set data representing the first overlapping period at the control packet, and output the control packet to the communication interface.

10. The relay apparatus according to claim 9, wherein the control packet further includes the identifier allocated to the transmission of the data packet group,
wherein when the first overlapping period is a period identified with respect to the use enable period, the processor is configured to register, in a relay table, reservation information, the reservation information including data representing a reservation period into which the first overlapping period is shifted by the shift time in a direction opposite to the direction of the idling time of the communication interface, the identifier included in the control packet, and identification information of a second communication interface and the first communication interface; and
wherein when the first overlapping period is a period identified with respect to the idling time of the transmission source interface, the processor is configured to register, in the relay table, the reservation information, the reservation information including, as data representing the reservation period, data representing the first overlapping period, the identifier included in the control packet, and the identification information of the second communication interface and the first communication interface.

11. The relay apparatus according to claim 10, further comprising a switching module,
wherein a leading packet of the data packet group includes the identifier allocated to the transmission of the data packet group; and
wherein in response to the reception of the leading packet of the data packet group, the switching module is configured to identify the first communication interface corresponding to the identification information of the second communication interface and the identifier included in the leading packet of the data packet group in the relay table, output the data packet group to the first communication interface until a reception end of a trailing packet of the data packet group, identify a second overlapping period of a reservation period corresponding to the identification information of the second communication interface and the identifier included in the leading packet of the data packet group in the relay table, and a period from a reception start of the leading packet of the data packet group to a reception end of the trailing packet of the data packet group, and update the reservation period in the relay table with the identified second overlapping period.
